(19) United States
(12) Patent Application Publication
(10) Pub. No.: US 2023/0335748 A1
(43) Pub. Date: Oct. 19, 2023

(54) ELECTROCHEMICAL CELLS WITH DENDRITE PREVENTION MECHANISMS AND METHODS OF MAKING THE SAME

(71) Applicant: 24M Technologies, Inc., Cambridge, MA (US)

(72) Inventors: Junzheng CHEN, Concord, MA (US); Naoki OTA, Lexington, MA (US); Xiaoming LIU, Newton, MA (US)

(21) Appl. No.: 18/140,883

(22) Filed: Apr. 28, 2023

Related U.S. Application Data
(63) Continuation of application No. PCT/US2021/057727, filed on Nov. 2, 2021.
(60) Provisional application No. 63/108,560, filed on Nov. 2, 2020.

(51) Int. Cl. H01M 4/62; H01M 4/587; H01M 4/525; H01M 10/04; H01M 50/186; H01M 50/105; H01M 4/505; H01M 4/133; H01M 4/131

(52) U.S. Cl. CPC H01M 4/628; H01M 4/587; H01M 4/525; H01M 10/049; H01M 50/186; H01M 50/105; H01M 4/505; H01M 4/133; H01M 4/131

(57) ABSTRACT

Embodiments described herein relate generally to electrochemical cells with dendrite prevention mechanisms. In some embodiments, an electrochemical cell can include an anode disposed on an anode current collector, a cathode disposed on a cathode current collector, and a separator disposed between the anode and the cathode. In some embodiments, at least one of the anode or the cathode includes a first portion and a second portion, the second portion configured to prevent dendrite formation around an outside edge of the anode and/or the cathode. In some embodiments, the second portion can include an electroactive material disposed on the anode current collector around an outside edge of the anode current collector. In some embodiments, the second portion can include an electroactive material disposed on a pouch material around an outside edge of the anode current collector.

### CROSS REFERENCE TO RELATED APPLICATIONS

This application claims the benefit of U.S. Provisional Application No. 63/108,560, filed Nov. 2, 2020, the content of which is incorporated herein by reference in its entirety.

### TECHNICAL FIELD

Embodiments described herein relate generally to electrochemical cells with dendrite prevention mechanisms.

### BACKGROUND

Consumers want a battery that can charge quickly and that can store enough energy to carry out any intended application for as long as desired. In order to achieve the desired theoretical energy density, battery manufacturers have increased the thickness of the electrodes to increase the total ion/electron storage capacity of the electrodes. However, these thicker electrodes often result in a portion of the active material being largely unavailable for ion/electron storage because of the reduced conductivity across portions of these electrodes as a function of electrode thickness. Battery manufacturers have also used high-capacity materials in electrodes (e.g., anodes) to increase the theoretical energy density, however these materials often expand and contract volumetrically during use of the electrode, which can damage the battery. Thus, it is an enduring goal of energy storage systems development to reduce inactive components in the electrodes and finished batteries and to increase energy density and overall performance.

Additionally, dendrite formation and growth, as well as plating are problems experienced in lithium ion electrochemical cells. Dendrites can begin to form when lithium ions start to clump or nucleate on a surface of an electrode (i.e., a nucleation site). Dendrites grow when additional lithium ions migrate to the nucleation site and bind to the nucleation site. Dendrite formation and plating can be exacerbated by fast charging and discharging of electrochemical cells, as faster charge and discharge lead to a higher density of ion movement. Dendrite growth and plating are detrimental to cyclability of an electrochemical cell, as they can cause active materials to be irreversibly lost. Dendrites can also block the flow of ions or cause partial or full short circuit conditions in the electrochemical cell.

### SUMMARY

Embodiments described herein relate generally to electrochemical cells with dendrite prevention mechanisms. In some embodiments, an electrochemical cell can include an anode disposed on an anode current collector, a cathode disposed on a cathode current collector, and a separator disposed between the anode and the cathode. In some embodiments, at least one of the anode or the cathode includes a first portion and a second portion, the second portion configured to prevent dendrite formation around an outside edge of the anode and/or the cathode. In some embodiments, the second portion can include an electroactive material disposed on the anode current collector around an outside edge of the anode current collector. In some embodiments, the second portion can include an electroactive material disposed on a pouch material around an outside edge of the anode current collector. In some embodiments, the second portion can include a non-wettable coating disposed on the cathode current collector around an outside edge of the cathode

In some aspects, an electrochemical cell described herein can include an anode disposed on an anode current collector, a cathode disposed on a cathode current collector; and a separator disposed between the anode and the cathode. The separator has a first side adjacent to the anode and a second side adjacent to the cathode, wherein at least one of the anode or the cathode includes a first portion and a second portion, the second portion configured to prevent dendrite formation around an outside edge of the anode and/or the cathode. In some embodiments, the second portion includes an electroactive material disposed on the anode current collector around an outside edge of the anode current collector. In some embodiments, the electroactive material includes LiTO₂, TiO₂ or any combination thereof. In some embodiments, the second portion includes an electroactive material disposed on a pouch material around an outside edge of the anode current collector. In some embodiments, the electroactive material includes LiTO₂, TiO₂ or any combination thereof. In some embodiments, the second portion includes a non-wettable coating disposed on the cathode current collector around an outside edge of the cathode.

Thus, in some aspects, an electrochemical cell can include:
an anode disposed on an anode current collector;
a cathode disposed on a cathode current collector; and
a separator disposed between the anode and the cathode, the separator having a first side adjacent to the anode and a second side adjacent to the cathode,
wherein at least one of the anode or the cathode includes a first portion and a second portion, the second portion configured to prevent dendrite formation around an outside edge of the anode and/or the cathode.

In some embodiments, the first portion is a first electroactive material and the second portion is a second electroactive material.

In some embodiments, the first portion is a first electroactive material and the second portion is a second electroactive material, the anode includes a first portion and a second portion, wherein the second portion is disposed on the anode current collector around an outside edge of the anode current collector.

In some embodiments, the anode includes a first portion and a second portion, wherein the second portion is disposed on a pouch material around an outside edge of the anode current collector.

In some embodiments, the anode includes a first portion and a second portion, wherein the second portion is disposed on the anode current collector around at least part of an outside edge of the first portion.

In some embodiments, the anode includes a first portion and a second portion, wherein the second portion is disposed on the anode current collector around an outside edge of the anode current collector and around at least part of an outside edge of the first portion. Optionally, in a further embodiment, during use a portion of the cathode migrates to a region surrounding the cathode current collector to form a migrated portion of the cathode. Optionally, in a further embodiment, during use the second portion of the anode can capture electrons and/or ions transported from the migrated portion of the cathode across the separator. In some embodiments, a non-wettable coating is disposed around an outside edge of the cathode current collector. In some embodiments, a non-wettable coating is disposed on the cathode current collector around an outside edge of the cathode. In some embodiments, when a non-wettable coating is present, during use, the non-wettable coating repels fragments of the cathode to form the migrated portion of the cathode in an outside region surrounding the non-wettable coating, or, during use, the non-wettable coating facilitates movement of fragments of the cathode to form the migrated portion of the cathode via a wicking action.

In some embodiments, the first portion is a first electroactive material and the second portion is a second electroactive material, the cathode includes a first portion and a second portion, wherein the second portion is disposed on the cathode current collector around an outside edge of the cathode current collector;
or wherein the cathode includes a first portion and a second portion, wherein the second portion is disposed on a pouch material around an outside edge of the cathode current collector;
or wherein the cathode includes a first portion and a second portion, wherein the second portion is disposed on the cathode current collector around at least part of an outside edge of the first portion;
or wherein the cathode includes a first portion and a second portion, wherein the second portion is disposed on the cathode current collector around an outside edge of the cathode current collector and around at least part of an outside edge of the first portion. In some embodiments, during use, a portion of the anode migrates to a region surrounding the anode current collector to form a migrated portion of the anode. In some embodiments, a non-wettable coating is disposed around an outside edge of the anode current collector or wherein a non-wettable coating is disposed on the anode current collector around an outside edge of the anode. In some embodiments, when a non-wettable coating is present, during use, the non-wettable coating repels fragments of the anode to form the migrated portion of the anode in an outside region surrounding the non-wettable coating or during use, the non-wettable coating facilitates movement of fragments of the anode to form the migrated portion of the anode via a wicking action.

In some embodiments, the first portion is a first electroactive material and the second portion is a second electroactive material, the second electroactive material includes a high-capacity material. In a further embodiment, the second electroactive material includes silicon, bismuth, boron, gallium, indium, zinc, tin, antimony, aluminum, titanium oxide, molybdenum, germanium, manganese, niobium, vanadium, tantalum, iron, copper, gold, platinum, chromium, nickel, cobalt, zirconium, yttrium, molybdenum oxide, germanium oxide, silicon oxide, silicon carbide, or any combination thereof. In some embodiments, the second electroactive material includes silicon. In a further embodiment, the second electroactive material includes LiTO₂, TiO₂ or any combination thereof.

In some embodiments, a thickness of the second portion is the same as a thickness of the current collector. In some embodiments, the first portion is a first electroactive material and the second portion is a second electroactive material, the first electroactive material is composed of the same material as the second electroactive material, alternatively, the first electroactive material is composed of a different material than the second electroactive material. In some embodiments, the second electroactive material is a higher or lower voltage material than the first electroactive material. In some embodiments, the second electroactive material is a higher voltage material than the first electroactive material. In some embodiments, during use, electrons and/or ions are transported to the first portion from the second portion, or from the first portion to the second portion, during use, electrons and/or ions are transported to the first portion from the second portion.

In some embodiments, the first portion is a first electroactive material, and the second portion is a second electroactive material and wherein a non-wettable coating is present, the non-wettable coating acts as an electronic barrier or the non-wettable coating resists wetting from electrolyte.

In some embodiments, the second portion is a non-wettable coating. In a further embodiment, the anode includes a first portion and a second portion, wherein the second portion of the anode is disposed around an outside edge of the anode current collector. In a yet further embodiment, the cathode includes a first portion and a second portion, wherein the second portion of the cathode is disposed around an outside edge of the cathode current collector. In a further embodiment the anode includes a first portion and a second portion, wherein the second portion of the anode is disposed around an outside edge of the anode current collector and the cathode includes a first portion and a second portion, wherein the second portion of the cathode is disposed around an outside edge of the cathode current collector. In an embodiment, the non-wettable coating is disposed on a pouch material. In another embodiment the non-wettable coating acts as an electronic barrier or the non-wettable coating resists wetting from electrolyte.

In some embodiments, the second portion is a non-wettable coating, the anode includes a first portion and a second portion, wherein the second portion of the anode, is disposed on the anode current collector around an outside edge of the first portion of the anode, and/or the cathode includes a first portion and a second portion, wherein the second portion of the cathode is disposed on the cathode current collector around an outside edge of the first portion of the cathode. In a further embodiment, the second portion including the non-wettable coating is disposed on the anode current collector around an outside edge of the first portion of the anode. In a further embodiment, the second portion including the non-wettable coating is disposed on the cathode current collector around an outside edge of the first portion of the cathode. In another embodiment the non-wettable coating acts as an electronic barrier or the non-wettable coating resists wetting from electrolyte,

In some embodiments, the second portion is a non-wettable coating, the second portion is a second portion of the anode and, during use, the non-wettable coating repels fragments of the first portion of the anode to form a migrated portion of the anode in an outside region surrounding the non-wettable coating or facilitates movement of fragments of the first portion of the anode to form a migrated portion of the anode via a wicking action. In some embodiments, the second portion is a non-wettable coating, the second portion is a second portion of the cathode and, during use, the non-wettable coating repels fragments of the first portion of the cathode to form a migrated portion of the cathode in an outside region surrounding the non-wettable coating, or facilitates movement of fragments of the first portion of the cathode to form a migrated portion of the cathode via a wicking action.

In some embodiments, the electrochemical cell includes a non-wettable coating, a thickness of the non-wettable coating is the same as a thickness of the anode current collector and/or cathode collector on or around which it is disposed. In some embodiments, wherein the electrochemical cell includes a non-wettable coating, the non-wettable coating comprises polytetrafluoroethylene (PTFE), polyimide, polyethylene terephthalate (PET), silicone, alumina, silica, perfluoro-alkyl-polyacrylate resins and polymers, polysilsesquioxane, poly(vinyl alcohol) based co-polymer with polydioctylfluorene (PFO), poly(vinyl alcohol) based co-polymer combined with silica/alumina as an oil repellent coating, or any combination thereof.

In some aspects, an electrochemical cell can include:
an anode disposed on an anode current collector;
a cathode disposed on a cathode current collector; and
a separator disposed between the anode and the cathode, the separator having a first side adjacent to the anode and a second side adjacent to the cathode,
wherein a non-wettable coating is disposed on the anode current collector around an outside edge of the anode and/or a non-wettable coating is disposed on the cathode current collector around an outside edge of the cathode

In some embodiments, the non-wettable coating is disposed on the anode current collector around an outside edge of the anode. In another embodiment, the non-wettable coating is disposed on the cathode current collector around an outside edge of the cathode.

In some aspects, an electrochemical cell can include:
an anode disposed on an anode current collector;
a cathode disposed on a cathode current collector; and
a separator disposed between the anode and the cathode, the separator having a first side adjacent to the anode and a second side adjacent to the cathode,
wherein a non-wettable coating is disposed around an outside edge of the anode current collector and/or a non-wettable coating is disposed around an outside edge of the cathode current collector.

In some embodiments, the non-wettable coating is disposed around an outside edge of the anode current collector. In some embodiments, the non-wettable coating is disposed around an outside edge of the cathode current collector. In some embodiments, the non-wettable coating is disposed on a pouch material.

In some embodiments, the non-wettable coating is disposed on the anode current collector or around the outside edge of the anode current collector and, during use, the non-wettable coating: repels fragments of the anode to form a migrated portion of the anode in an outside region surrounding the non-wettable coating or facilitates movement of fragments of anode to form a migrated portion of the anode via a wicking action. In some embodiments, the non-wettable coating is disposed on the cathode current collector or around the outside edge of the cathode current collector and, during use, the non-wettable coating: repels fragments of the cathode to form a migrated portion of the cathode in an outside region surrounding the non-wettable coating, or facilitates movement of fragments of cathode to form a migrated portion of the cathode via a wicking action. In some embodiments, a thickness of the non-wettable coating is the same as a thickness of the cathode current collector or anode current collector on or around which it is disposed.

In some embodiments, the non-wettable coating comprises polytetrafluoroethylene (PTFE), polyimide, polyethylene terephthalate (PET), silicone, alumina, silica, perfluoro-alkyl-polyacrylate resins and polymers, polysilsesquioxane, poly(vinyl alcohol) based co-polymer with polydioctylfluorene (PFO), poly(vinyl alcohol) based co-polymer combined with silica/alumina as an oil repellent coating, or any combination thereof.

In some embodiments, at least the first portion of the anode and/or cathode is a semi-solid anode material and/or a semi solid cathode material. In some embodiments, at least the first portion of the anode is a graphite electrode. In some embodiments, at least the first portion of the cathode includes NMC 811. In some embodiments, the anode, anode current collector, cathode, cathode current collector, separator, first portion and second portion are disposed in a pouch. In some embodiments, portions of the separator extend beyond the edges of the anode and cathode. In some embodiments, portions of the separator extend beyond the edges of the anode and cathode, the anode, anode current collector, cathode, cathode current collector, separator, first portion and second portion are disposed in a pouch and the portions of the separator that extend beyond the edges of the anode and cathode are sealed to portions of the pouch.

In some aspects, a method of preparing an electrochemical cell can include:
a) disposing a first portion of an anode on an anode current collector;
b) disposing a first portion of a cathode on a cathode current collector;
c) disposing a separator between the first anode portion and the first cathode portion;
d) disposing a second portion of the anode on the anode current collector around an outside edge of the anode current collector, and/or disposing a second portion of the cathode on the cathode current collector around an outside edge of the cathode current collector;
e) disposing the anode current collector, anode, cathode current collector, cathode and separator in a pouch; and
f) sealing the pouch to form the electrochemical cell.

In some aspects, a method of preparing an electrochemical cell can include:
a) disposing a first portion of an anode on an anode current collector;
b) disposing a first portion of a cathode on a cathode current collector;
c) disposing a separator between the first anode portion and the first cathode portion;
d) disposing the anode current collector, anode, cathode current collector, cathode and separator in a pouch;
e) disposing a second portion of the anode and/or a second portion of the cathode on the pouch material around an outside edge of the anode current collector and/or cathode current collector respectively; and
f) sealing the pouch to form the electrochemical cell.

In some aspects, a method of preparing an electrochemical cell can include:
a) disposing a first portion of an anode on an anode current collector;
b) disposing a first portion of a cathode on a cathode current collector;
c) disposing a separator between the first anode portion and the first cathode portion;
d) disposing a second portion of the anode on the anode current collector around at least part of an outside edge of the first anode portion, and/or disposing a second portion of the cathode on the cathode current collector around at least part of an outside edge of the first cathode portion;
e) disposing the anode current collector, anode, cathode current collector, cathode and separator in a pouch; and
f) sealing the pouch to form the electrochemical cell.

In some aspects, a method of preparing an electrochemical cell can include:
a) disposing a first portion of an anode on an anode current collector;
b) disposing a first portion of a cathode on a cathode current collector;
c) disposing a separator between the first anode portion and the first cathode portion;
d) disposing a second portion of the anode around an outside edge of the anode current collector and around at least part of an outside edge of the first anode portion, and/or disposing a second portion of the cathode around an outside edge of the cathode current collector and around at least part of an outside edge of the first cathode portion;
e) disposing the anode current collector, anode, cathode current collector, cathode and separator in a pouch; and
f) sealing the pouch to form the electrochemical cell.

In some embodiments, the first portion is a first electroactive material and the second portion is a second electroactive material.

In some embodiments, the second portion of the anode is disposed on the anode current collector around an outside edge of the anode current collector, on the pouch material around the outside edge of the anode current collector, on the anode current collector around at least part of an outside edge of the first portion of the anode, or around an outside edge of the anode current collector and around at least part of an outside edge of the first portion of the anode. In a further embodiment, the method further comprises the step of disposing a non-wettable coating around an outside edge of the cathode current collector or the step of disposing a non-wettable coating on the cathode current collector around an outside edge of the first portion of the cathode.

In some embodiments, the second portion of the cathode is disposed on the cathode current collector around an outside edge of the cathode current collector, on the pouch material around the outside edge of the cathode current collector, on the cathode current collector around at least part of an outside edge of the first portion of the cathode, or around an outside edge of the cathode current collector and around at least part of an outside edge of the first portion of the cathode. In a further embodiment, the method further comprises the step of disposing a non-wettable coating around an outside edge of the anode current collector or the step of disposing a non-wettable coating on the anode current collector around an outside edge of the first portion of the anode.

In some embodiments, the second portion of the anode is disposed on the anode current collector around an outside edge of the anode current collector, on the pouch material around the outside edge of the anode current collector, on the anode current collector around at least part of an outside edge of the first portion of the anode, or around an outside edge of the anode current collector and around at least part of an outside edge of the first portion of the anode; and the second portion of the cathode is disposed on the cathode current collector around an outside edge of the cathode current collector, on the pouch material around the outside edge of the cathode current collector, on the cathode current collector around at least part of an outside edge of the first portion of the cathode, or around an outside edge of the cathode current collector and around at least part of an outside edge of the first portion of the cathode.

In some aspects, a method of preparing an electrochemical cell can include:
a) disposing a first portion of an anode on an anode current collector;
b) disposing a first portion of a cathode on a cathode current collector;
c) disposing a separator between the first anode portion and the first cathode portion;
d) disposing a non-wettable portion around an outside edge of the cathode current collector and/or the anode current collector;
e) disposing the anode current collector, anode, cathode current collector, cathode, separator and non-wettable portion(s) in a pouch; and
f) sealing the pouch to form an electrochemical cell.

In some aspects, a method of preparing an electrochemical cell can include:
a) disposing a first portion of an anode on an anode current collector;
b) disposing a first portion of a cathode on a cathode current collector;
c) disposing a separator between the first anode portion and the first cathode portion;
d) disposing a non-wettable portion on the cathode current collector and/or anode current collector and around an outside edge of the cathode and/or anode;
e) disposing the anode current collector, anode, cathode current collector, cathode, separator and non-wettable portion(s) in a pouch; and
f) sealing the pouch to form an electrochemical cell.

In some embodiments, the non-wettable portion is disposed around an outside edge of the cathode current collector or on the cathode current collector and around an outside edge of the first portion of the cathode. In a further embodiment wherein the non-wettable portion is disposed around an outside edge of the cathode current collector or on the cathode current collector and around an outside edge of the first portion of the cathode, the method can further comprise the step of disposing a second portion of the anode on the anode current collector around an outside edge of the anode current collector, on the pouch material around the outside edge of the anode current collector, on the anode current collector around at least part of an outside edge of the first portion of the anode, or around an outside edge of the anode current collector and around at least part of an outside edge of the first portion of the anode.

In some embodiments, the non-wettable portion is disposed around an outside edge of the anode current collector or on the anode current collector and around an outside edge of the first portion of the anode. In a further embodiment wherein the non-wettable portion is disposed around an outside edge of the anode current collector or on the anode current collector and around an outside edge of the first portion of the anode, the method can further comprise the step of disposing a second portion of the cathode on the cathode current collector around an outside edge of the cathode current collector, on the pouch material around the outside edge of the cathode current collector, on the cathode current collector around at least part of an outside edge of the first portion of the cathode, or around an outside edge of the cathode current collector and around at least part of an outside edge of the first portion of the cathode.

In some embodiments, portions of the separator extend beyond the edges of the anode and cathode. In some embodiments, the method can further comprise the step of heat sealing the pouch to the separator. In some embodiments, the method can further comprise the step of heat sealing portions of the pouch to each other.

In some embodiments, at least the first portion of the anode is a semi-solid anode material and/or at least the first portion of the cathode is a semi solid cathode material. In some embodiments, at least the first portion of the anode is a graphite electrode. In some embodiments, at least the first portion of the cathode includes NMC 811. In some embodiments, the second portion is an electroactive material which is a high-capacity material. In some embodiments, the second portion is an electroactive material which includes silicon, bismuth, boron, gallium, indium, zinc, tin, antimony, aluminum, titanium oxide, molybdenum, germanium, manganese, niobium, vanadium, tantalum, iron, copper, gold, platinum, chromium, nickel, cobalt, zirconium, yttrium, molybdenum oxide, germanium oxide, silicon oxide, silicon carbide, or any combination thereof. In an embodiment of any of the fourth to ninth aspects, the second portion is an electroactive material which includes LiTO₂, TiO₂ or any combination thereof.

In some aspects, the present invention provides the use of an electrochemical cell as hereinbefore described in any of the aforementioned embodiments.

In some aspects, the present invention provides a cell stack comprising at least one electrochemical cell as hereinbefore described in any of the aforementioned embodiments. In an embodiment of the eleventh aspect, the cell stack comprises at least two electrochemical cells as hereinbefore described in any of the aforementioned embodiments.

### BRIEF DESCRIPTION OF THE DRAWINGS

FIG. 1 is a schematic illustration of an electrochemical cell, according to an embodiment.

FIG. 2 is a schematic illustration of an electrochemical cell, according to an embodiment.

FIG. 3 is a schematic illustration of an electrochemical cell including expansion areas, according to an embodiment.

FIG. 4 is a schematic illustration of an electrochemical cell, according to an embodiment.

FIG. 5 is a schematic illustration of an electrochemical cell, according to an embodiment.

FIG. 6 is a schematic illustration of an electrochemical cell, according to an embodiment.

FIGS. 7A-7B are schematic illustrations of an electrochemical cell, according to an embodiment.

FIG. 8 is a schematic illustration of an electrochemical cell, according to an embodiment.

FIG. 9 is a schematic illustration of an electrochemical cell, according to an embodiment.

FIG. 10 is a schematic illustration of an electrochemical cell, according to an embodiment.

FIG. 11 is a graphical representation of initial capacity loss in different electrochemical cell configurations.

FIG. 12 is a graphical representation of capacity retention vs. number of cycles in different electrochemical cell configurations.

FIG. 13 is a graphical representation of capacity retention vs. number of cycles and C-rate in different electrochemical cell configurations.

FIG. 14 is a graphical representation of capacity retention vs. number of cycles and C-rate in different electrochemical cell configurations.

FIG. 15 is a graphical representation of dQ/dV and voltage profile comparisons between different electrochemical cell configurations.

FIG. 16 is a graphical representation of half cell voltage curves for lithium manganese iron phosphate.

FIGS. 17A-17B are a graphical representations of capacity retention vs. number of cycles in different electrochemical cell configurations.

FIG. 18 is a graphical representation of an electrochemical cell, according to an embodiment.

FIG. 19 is a graphical representation of an electrochemical cell, according to an embodiment.

FIG. 20 shows an electrochemical cell subject to short circuit from deposition of anode material.

### DETAILED DESCRIPTION

Embodiments described herein relate generally to electrochemical cells with multiple-layered electrodes, coated separators and/or with dendrite prevention mechanisms.

Conventional battery systems store electrochemical energy by separating an ion source and ion sink at differing ion electrochemical potential. A difference in electrochemical potential produces a voltage difference between the positive and negative electrodes, which produces an electric current if the electrodes are connected by a conductive element. Differences in electrochemical potential between the positive and negative electrodes may produce a higher voltage system, which contributes to higher energy density cells. In a conventional battery system, negative electrodes and positive electrodes are connected via a parallel configuration of two conductive elements. The external elements exclusively conduct electrons, however, the internal elements, being separated by a separator and electrolyte, exclusively conduct ions. The external and internal flow streams supply ions and electrons at the same rate, as a charge imbalance cannot sustain between the negative electrode and positive electrode. The produced electric current can drive an external device. A rechargeable battery can be recharged by application of an opposing voltage difference that drives electric and ionic current in an opposite direction as that of a discharging battery. Accordingly, active material of a rechargeable battery should have the ability to accept and provide ions. Increased electrochemical potentials produce larger voltage differences between the cathode and anode of a battery, which increases the electrochemically stored energy per unit mass of the battery.

Consumer electronic batteries have gradually increased in energy density with the progress of lithium-ion battery technology. The stored energy or charge capacity of a manufactured battery is a function of: (1) the inherent charge capacity of the active material (mAh/g), (2) the volume of the electrodes (cm³) (i.e., the product of the electrode thickness, electrode area, and number of layers (stacks)), and (3) the loading of active material in the electrode media (e.g., grams of active material per cm³ of electrode media). Therefore, to enhance commercial appeal (e.g., increased energy density and decreased cost), it is generally desirable to increase the areal charge capacity (mAh/cm²). The areal charge capacity can be increased, for example, by utilizing active materials that have a higher inherent charge capacity, increasing relative percentage of active charge storing material (i.e., “loading”) in the overall electrode formulation, and/or increasing the relative percentage of electrode material used in any given battery form factor. Said another way, increasing the ratio of active charge storing components (e.g., the electrodes) to inactive components (e.g., the separators and current collectors), increases the overall energy density of the battery by eliminating or reducing components that are not contributing to the overall performance of the battery. One way to accomplish increasing the areal charge capacity, and therefore reducing the relative percentage of inactive components, is by increasing the thickness of the electrodes.

Conventional electrode compositions generally cannot be made thicker than about 100 μm because of certain performance and manufacturing limitations. For example, i) conventional electrodes having a thickness over 100 μm (single sided coated thickness) typically have significant reductions in their rate capability due to diffusion limitations through the thickness of the electrode (e.g., porosity, tortuosity, impedance, etc.) which grows rapidly with increasing thickness; ii) thick conventional electrodes are difficult to manufacture due to drying and post processing limitations, for example, solvent removal rate, capillary forces during drying that leads to cracking of the electrode, poor adhesion of the electrode to the current collector leading to delamination (e.g., during the high speed roll-to-roll calendering process used for manufacturing conventional electrodes), migration of binder during the solvent removal process and/or deformation during a subsequent compression process; iii) without being bound to any particular theory, the binders used in conventional electrodes may obstruct the pore structure of the electrodes and increase the resistance to diffusion of ions by reducing the available volume of pores and increasing tortuosity (i.e., effective path length) by occupying a significant fraction of the space between the functional components of the electrodes (i.e., active and conductive components). It is also known that binders used in conventional electrodes can at least partially coat the surface of the electrode active materials, which slows down or completely blocks the flow of ions to the active materials, thereby increasing tortuosity.

Furthermore, known conventional batteries either have high capacity or high rate capability, but not both. A battery having a first charge capacity at first C-rate, for example, 0.5 C generally has a second lower charge capacity when discharged at a second higher C-rate, for example, 2 C. This is due to the higher energy loss that occurs inside a conventional battery due to the high internal resistance of conventional electrodes (e.g., solid electrodes with binders), and a drop in voltage that causes the battery to reach the low-end voltage cut-off sooner. A thicker electrode generally has a higher internal resistance and therefore a lower rate capability. For example, a lead acid battery does not perform well at 1 C C-rate. They are often rated at a 0.2 C C-rate and even at this low C-rate, they cannot attain 100% capacity. In contrast, ultra-capacitors can be discharged at an extremely high C-rate and still maintain 100% capacity, however, they have a much lower charge capacity than conventional batteries. Accordingly, a need exists for electrodes that can be made thicker and yet have superior performance characteristics such as superior rate capability and charge capacity. Gradients in physical properties and composition can aid the diffusion of electroactive species. Gradients in composition can include active material composition.

Therefore, embodiments described herein relate generally to electrodes having a compositional gradient in a z direction (also called “the [001] directions”), i.e., in a direction perpendicular to the surface of the current collector (hereafter “electrode thickness”). In other words, the electrode can be engineered to be at least partially anisotropic and/or heterogeneous in order to tailor the electrode for mechanical, chemical, and/or electrochemical performance enhancements. Examples of electrodes with multiple layers and/or compositional gradients can be found in U.S. Patent Publication No. US 2019/0363351, filed May 24, 2019 (the ′351 publication), entitled “High Energy-Density Composition Gradient Electrodes and Methods of Making the Same,” the entire disclosure of which is incorporated herein by reference.

In some embodiments, the electrodes and/or the electrochemical cells described herein can include solid-state electrolytes. In some embodiments, anodes described herein can include a solid-state electrolyte. In some embodiments, cathodes described herein can include a solid-state electrolyte. In some embodiments, electrochemical cells described herein can include solid-state electrolytes in both the anode and the cathode. In some embodiments, the electrochemical cells described herein can include unit cell structures with solid-state electrolytes. In some embodiments, the solid-state electrolyte material can be a powder mixed with the binder and then processed (e.g., extruded, cast, wet cast, blown, etc.) to form the solid-state electrolyte material sheet. In some embodiments, solid-state electrolyte material is one or more of oxide-based solid electrolyte materials including a garnet structure, a perovskite structure, a phosphate-based Lithium Super Ionic Conductor (LISICON) structure, a glass structure such as La_{0.51}Li_{0.34}TiO_{2.94}, Li_{1.3}Al_{0.3}Ti_{1.7}(PO₄)₃, Li_{1.4}Al_{0.4}Ti_{1.6}(PO₄)₃, Li₇La₃Zr₂O₁₂, Li_{6.6}6La₃Zr_{1.6}Ta_{0.4}O_{12.9} (LLZO), 50Li₄SiO₄·50Li₃BO₃, Li_{2.9}PO_{3.3}N_{0.46} (lithium phosphorousoxynitride, LiPON), Li_{3.6}Si_{0.6}P_{0.4}O₄, Li₃BN₂, Li₃BO₃—Li₂SO₄, Li₃BO₃—Li₂SO₄—Li₂CO₃ (LIBSCO, pseudoternary system), and/or sulfide contained solid electrolyte materials including a thio-LISICON structure, a glassy structure and a glass-ceramic structure such as Li_{1.07}Al_{0.69}Ti_{1.46}(PO₄)₃, Li_{1.5}Al_{0.5}Ge_{1.5}(PO₄)₃, Li₁₀GeP₂S₁₂ (LGPS), 30Li₂S·26B₂S₃·44LiI, 63Li₂S·36SiS₂·1Li₃PO₄, 57Li₂S·38SiS₂·5Li₄SiO₄, 70Li₂S·30P₂S₅, 50Li₂S·50GeS₂, Li₇P₃S₁₁, Li_{3.25}P_{0.95}S₄, and Li_{9.54}Si_{1.74}P_{1.44}S_{11.7}Cl_{0.3}, and/or closo-type complex hydride solid electrolyte such as LiBH₄—LiI, LiBH₄—LiNH₂, LiBH₄—P₂S₅, Li(CB_{X}H_{X+1})—LiI like Li(CB₉H₁₀)—LiI, and/or lithium electrolyte salt bis(trifluoromethane)sulfonamide (TFSI), bis(pentalluoroethanesulfonyl)imide (BETI), bis(fluorosulfonyl)imide, lithium borate oxalato phosphine oxide (LiBOP), lithium bis(fluorosulfonyl)imide, amide-borohydride, LiBF₄, LiPF₆ LIF, or combinations thereof. In some embodiments, electrodes described herein can include about 40 wt. % to about 90 wt % solid-state electrolyte material. Examples of electrochemical cells and electrodes that include solid-state electrolytes are described in U.S. Pat. No. 10,734,672 entitled, “Electrochemical Cells Including Selectively Permeable Membranes, Systems and Methods of Manufacturing the Same,” filed Jan. 8, 2019 (“the ′672 patent”), the disclosure of which is incorporated herein by reference in its entirety.

While electrochemical cells with multiple layers or compositional gradients in the anode and/or cathode can deliver high capacity and high C-rates, charging at high C-rates can lead to cycling issues. Charging or discharging at high C-rates can cause lithium ions or other electroactive species to plate around the edges of the cathode, more so than at low C-rates, due to the high volume of ion movement. Additionally, charging or discharging at high C-rates can exacerbate dendrite growth for the same reasons. Over many cycles, dendrites can consume electroactive material and electrolyte in the electrochemical cells, causing irreversible capacity loss. When dendrites grow large enough, they can penetrate the separator, causing a partial short circuit or a full short circuit in the electrochemical cell. Short circuits can be a safety hazard, as they can potentially lead to ignition and fires in the electrochemical cell.

Coatings on the separator can reduce plating and dendrite growth via several mechanisms. Separator porosity is often a parameter with a relatively narrow workable range, depending on the chemistry of the electrochemical cell. Ion congestion can occur near separator pores. If a high porosity and/or high surface area material is used to coat the separator, the coating can increase the number of possible flow paths ions can follow when migrating from one electrode to the other. This can significantly reduce the congestion of ions near the separator pores, as the ions can migrate through a branched network of pores rather than single file. This reduction in ion congestion can aid in preventing dendrite buildup, thereby improving capacity retention of the electrochemical cell through multiple cycles.

As used herein, “composition” can be anisotropic and can refer to physical, chemical, or electrochemical composition or combinations thereof. For example, in some embodiments, the electrode material directly adjacent to a surface of a current collector can be less porous than electrode material further from the surface of the current collector. Without wishing to be bound by any particular theory, the use of a porosity gradient, for example, may result in an electrode that can be made thicker without experiencing reduced ionic conductivity. In some embodiments, the composition of the electrode material adjacent to the surface of the current collector can be different chemically than the electrode material further from the surface of the current collector.

As used herein, the term “about” and “approximately” generally mean plus or minus 10% of the value stated, e.g., about 250 μm would include 225 μm to 275 μm, about 1,000 μm would include 900 μm to 1,100 μm.

As used herein, the term “semi-solid” refers to a material that is a mixture of liquid and solid phases, for example, such as particle suspension, colloidal suspension, emulsion, gel, or micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L) of the materials included for the electrochemical cell to operate such as, the electrodes, the separator, the electrolyte, and the current collectors. Specifically, the materials used for packaging the electrochemical cell are excluded from the calculation of volumetric energy density.

As used herein, the terms “high-capacity materials” or “high-capacity anode materials” refer to materials with irreversible capacities greater than 300 mAh/g that can be incorporated into an electrode in order to facilitate uptake of electroactive species. Examples include tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

As used herein, the term “composite high-capacity electrode layer” refers to an electrode layer with both a high-capacity material and a traditional anode material, e.g., a silicon-graphite layer.

As used herein, the term “solid high-capacity electrode layer” refers to an electrode layer with a single solid phase high-capacity material, e.g., sputtered silicon, tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

In some embodiments, the compositional gradient can include any physical, chemical, and/or electrochemical characteristic of the electrode material. In some embodiments, the compositional gradient can include a change in porosity of the electrode material across the electrode thickness. In some embodiments, the compositional gradient can include a change in an active material or an active material concentration across the electrode thickness. In some embodiments, the compositional gradient can include a change in a conductive material or a conductive material concentration across the electrode thickness. In some embodiments, the compositional gradient can include a change in an electrolyte or an electrolyte concentration across the electrode thickness. In some embodiments, the compositional gradient can include a change in an additive (e.g., an electrolyte additive) or an additive concentration across the electrode thickness. In some embodiments, the compositional gradient can include a change in density (unit mass per unit volume) across the electrode thickness. In some embodiments, the compositional gradient can include a change in a degree of crystallinity of a material across the electrode thickness. In some embodiments, the compositional gradient can include change between at least one of cubic, hexagonal, tetragonal, rhombohedral, orthorhombic, monoclinic, and triclinic crystal structures across the electrode thickness. In some embodiments, the compositional gradient can include a change in pH across the electrode thickness. In some embodiments, the compositional gradient can include a change in ionic conductivity across the electrode thickness. In some embodiments, the compositional gradient can include a change in electron conductivity across the electrode thickness. In some embodiments, the compositional gradient can include a change in energy density across the electrode thickness. In some embodiments, the compositional gradient can include a change in theoretical energy density across the electrode thickness. In some embodiments, the compositional gradient can include a change in Young's modulus across the electrode thickness. In some embodiments, the compositional gradient can include a change in yield strength across the electrode thickness. In some embodiments, the compositional gradient can include a change in tensile strength across the electrode thickness. In some embodiments, the compositional gradient can include a change in volumetric expansion/contraction potential across the electrode thickness during operation of the electrochemical cell. In some embodiments, the compositional gradient can include a change in plastic deformability of the electrode material across the electrode gradient. In some embodiments, the compositional gradient can include a change in solubility of at least one of the active material, the conductive material, and the additive in the electrolyte across the electrode thickness. In some embodiments, the compositional gradient can include a change in binder percentage across the electrode thickness. In some embodiments, the compositional gradient can include a change in workability of the electrode material across the electrode thickness. In some embodiments, the compositional gradient can include a change in the flowability of the electrode material across the electrode thickness. In some embodiments, the compositional gradient can include a change in ion storage potential across the electrode thickness. In some embodiments, the compositional gradient can include a change in a capacity fade experienced after initial charge/discharge cycling across the electrode thickness. In some embodiments, the compositional gradient can include a change in viscosity across the electrode thickness. In some embodiments, the compositional gradient can include a change in density across the electrode thickness. In some embodiments, the compositional gradient can include a change in surface area across the electrode thickness. In some embodiments, the change in surface area across the electrode thickness can be due to a change in active material concentration (i.e., higher concentration of active material closer to the current collector than further away or vice versa). In some embodiments, the change in surface area across the electrode thickness can be due to a change in active material composition (i.e., different active material composition close to the current collector from the active material composition further from the current collector).

In some embodiments, in order to accomplish a compositional gradient through the electrode thickness, a number of compositionally distinct electrode materials can be disposed on the current collector (e.g., as a laminate structure). In some embodiments, the number of compositionally distinct electrode materials can be greater than 1, greater than about 2, greater than about 3, greater than about 4, greater than about 5, greater than about 6, greater than about 7, greater than about 8, greater than about 9, greater than about 10, or greater than about 15 layers, inclusive of all values and ranges therebetween. In some embodiments, a first layer can be disposed onto a current collector, a second layer can be disposed onto the first layer, and subsequent layers can be disposed upon previous layers until a top layer is disposed to form the finished electrode. In some embodiments, a first one or more layers can be coupled with a second one or more other layers in any suitable order and using any suitable method, and the coupled layers can be disposed onto the current collector simultaneously to form the finished electrode. In some embodiments, a single electrode material can be formed on the current collector that has a compositional gradient (anisotropy) across the electrode thickness.

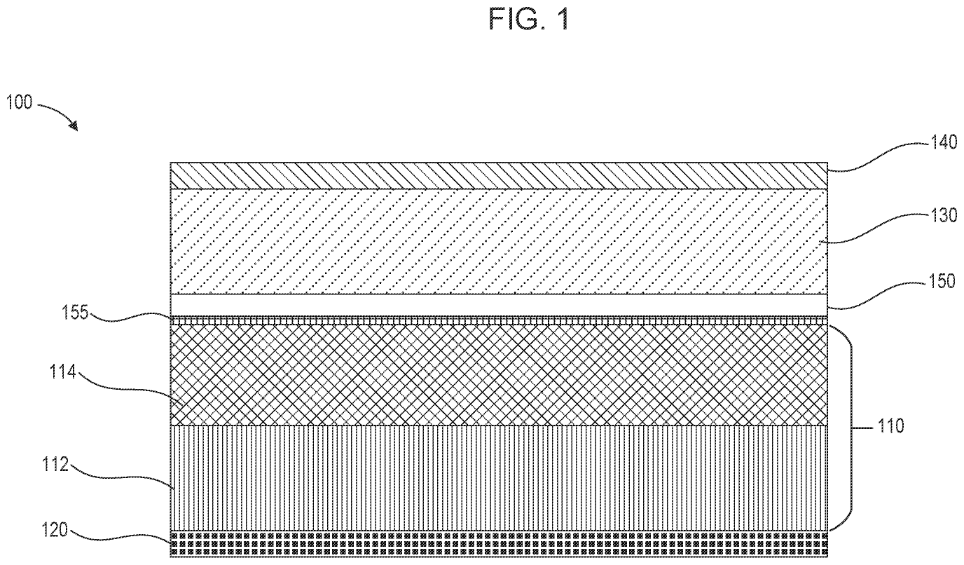

FIG. 1 is a schematic illustration of an electrochemical cell 100, including an anode 110 with a first electrode material 112 and a second electrode material 114, disposed on an anode current collector 120. The electrochemical cell 100 further includes a cathode 130 disposed on a cathode current collector 140 and a separator 150 disposed between the anode 110 and the cathode 130. A coating layer 155 is disposed on the separator 150.

As shown, the anode 110 is a dual-layered electrode. In some embodiments, the cathode 130 can be a dual-layered electrode. In some embodiments, both the anode 110 and the cathode 130 can be dual-layered electrodes. In some embodiments, the dual-layered electrode can include a range of materials and any suitable form factor as described in U.S. Pat. No. 8,993,159 (“the ′159 patent”), filed Apr. 29, 2013, entitled “Semi-Solid Electrodes Having High Rate Capability,” the entire disclosure of which is incorporated herein by reference.

Examples of possible materials, electrochemical compatibility characteristics, form factors, and uses for the anode current collector 120 and/or the cathode current collector 140 are described in further detail in the ′159 patent. In some embodiments, the anode current collector 120 and/or the cathode current collector 140 can be substantially similar to the current collectors described in the ′159 patent, and therefore is not described in detail herein.

In some embodiments, the anode current collector 120 and/or the cathode current collector 140 can include a conductive material in the form of a substrate, sheet or foil, or any other form factor. In some embodiments, the anode current collector 120 and/or the cathode current collector 140 can include a metal such as aluminum, copper, lithium, nickel, stainless steel, tantalum, titanium, tungsten, vanadium, or a mixture, combinations or alloys thereof. In some embodiments, the anode current collector 120 and/or the cathode current collector 140 can include a non-metal material such as carbon, carbon nanotubes, or a metal oxide (e.g., TiN, TiB₂, MoSi₂, n-BaTiO₃, Ti₂O₃, ReO₃, RuO₂, IrO₂, etc.). In some embodiments, the anode current collector 120 and/or the cathode current collector 140 can include a conductive coating disposed on any of the aforementioned metal and non-metal materials. In some embodiments, the conductive coating can include a carbon-based material, conductive metal and/or non-metal material, including composites or layered materials.

In some embodiments, electrode materials can include an active material, a conductive material, an electrolyte, an additive, a binder, and/or combinations thereof. In some embodiments, the active material can be an ion storage material and or any other compound or ion complex that is capable of undergoing Faradaic or non-Faradaic reactions in order to store energy. The active material can also be a multi-phase material including a redox-active solid mixed with a non-redox-active phase, including solid-liquid suspensions, or liquid-liquid multiphase mixtures, including micelles or emulsions having a liquid ion-storage material intimately mixed with a supporting liquid phase. Systems that utilize various working ions can include aqueous systems in which Li⁺, Na⁺, or other alkali ions are the working ions, even alkaline earth working ions such as Ca²⁺, Mg²⁺, or Al³⁺. In some embodiments, a negative electrode storage material and a positive electrode storage material may be electrochemically coupled to form the electrochemical cell, the negative electrode storing the working ion of interest at a lower absolute electrical potential than the positive electrode. The cell voltage can be determined approximately by the difference in ion-storage potentials of the two ion-storage electrode materials.

Electrochemical cells employing negative and/or positive ion-storage materials that are insoluble storage hosts for working ions may take up or release the working ion while all other constituents of the materials remain substantially insoluble in the electrolyte. In some embodiments, these cells can be particularly advantageous as the electrolyte does not become contaminated with electrochemical composition products. In addition, cells employing negative and/or positive lithium ion-storage materials may be particularly advantageous when using non-aqueous electrochemical compositions.

In some embodiments, the ion-storing redox compositions include materials proven to work in conventional lithium-ion batteries. In some embodiments, the positive semi-solid electroactive material contains lithium positive electroactive materials and the lithium cations are shuttled between the negative electrode and positive electrode, intercalating into solid, host particles suspended in a liquid electrolyte. In some embodiments, the lithium cations can intercalate into the solid matrix of a solid high-capacity material.

In some embodiments, the redox-active compound can be organic or inorganic, and can include but is not limited to lithium metal, sodium metal, lithium-metal alloys, gallium and indium alloys with or without dissolved lithium, molten transition metal chlorides, thionyl chloride, and the like, or redox polymers and organics that can be liquid under the operating conditions of the battery. Such a liquid form may also be diluted by or mixed with another, non-redox-active liquid that is a diluent or solvent, including mixing with such diluents to form a lower-melting liquid phase.

In some embodiments, the redox-active electrode material can include an organic redox compound that stores the working ion of interest at a potential useful for either the positive or negative electrode of a battery. Such organic redox-active storage materials include “p”-doped conductive polymers such as polyaniline or polyacetylene based materials, polynitroxide or organic radical electrodes (such as those described in: H. Nishide et al., Electrochim. Acta, 50, 827-831, (2004), and K. Nakahara, et al., Chem. Phys. Lett., 359, 351-354 (2002)), carbonyl based organics, and oxocarbons and carboxylate, including compounds such as Li₂C₆O₆, Li₂CsH₄O₄, and Li₂C₆H₄O₄ (see for example M. Armand et al., Nature Materials, DOI: 10.1038/nmat2372) and organosulfur compounds. In some embodiments, conventional active materials can include cobalt, manganese, nickel-cadmium-manganese, phosphate, lithium manganese oxide, lithium iron phosphate, lithium cobalt oxide, LiNi_{0.8}Co_{0.15}Al_{0.05}O₂, lithium nickel manganese oxide (LiNi0.5Mn0.5, LiNi0.5Mn1.5 etc.), lithium nickel cobalt manganese oxide (LiNi⅓Mn⅓Co⅓, etc.), lithium metal, carbon, lithium-intercalated carbon, lithium nitrides, lithium alloys and lithium alloy forming compounds of silicon, bismuth, boron, gallium, indium, zinc, tin, tin oxide, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide, and other suitable chemistries.

In some embodiments, the conductive material for electrode materials can include, for example, graphite, carbon powder, pyrloytic carbon, carbon black, carbon fibers, carbon microfibers, carbon nanotubes (CNTs), single walled CNTs, multi walled CNTs, fullerene carbons including “bucky balls,” graphene sheets and/or aggregate of graphene sheets, any other conductive material, metal (Cu, Al, powders, etc.), alloys or combination thereof.

In some embodiments, the electrolyte for electrode materials can include a non-aqueous liquid electrolyte that can include polar solvents such as, for example, alcohols or aprotic organic solvents. Numerous organic solvents have been proposed as the components of Li-ion battery electrolytes, notably a family of cyclic carbonate esters such as ethylene carbonate, propylene carbonate, butylene carbonate, and their chlorinated or fluorinated derivatives, and a family of acyclic dialkyl carbonate esters, such as dimethyl carbonate, diethyl carbonate, ethylmethyl carbonate, dipropyl carbonate, methyl propyl carbonate, ethyl propyl carbonate, dibutyl carbonate, butylmethyl carbonate, butylethyl carbonate and butylpropyl carbonate. Other solvents proposed as components of Li-ion battery electrolyte solutions include y-butyrolactone, dimethoxyethane, tetrahydrofuran, 2-methyl tetrahydrofuran, 1,3-dioxolane, 4-methyl-1,3-dioxolane, diethyl ether, sulfolane, methylsulfolane, acetonitrile, propiononitrile, ethyl acetate, methyl propionate, ethyl propionate, dimethyl carbonate, tetraglyme, and the like. In some embodiments, these nonaqueous solvents can be used as multi-component mixtures, into which a salt is dissolved to provide ionic conductivity. In some embodiments, salts to provide lithium conductivity can include LiClO₄, LiPF₆, LiBF₄, LiFSI, LiAsF₆, LiTFSI, LiBETI, LiBOB, and the like. In some embodiments, electrochemical cells can include a selectively permeable membrane is configured to isolate electrolyte molecules on the cathode side from electrolyte molecules on the anode side. This selectively permeable membrane can allow for the use of multiple electrolytes (i.e., an anolyte on the anode side and a catholyte on the cathode side), as described in U.S. Patent Publication No. US 2019/0348705 entitled, “Electrochemical Cells Including Selectively Permeable Membranes, Systems and Methods of Manufacturing the Same,” filed Jan. 8, 2019 (“the ′705 publication”), the disclosure of which is incorporated herein by reference in its entirety.

In some embodiments, the binder can include starch, carboxymethyl cellulose (CMC), diacetyl cellulose, hydroxypropyl cellulose, ethylene glycol, polyacrylates, poly(acrylic acid), polytetrafluoroethylene, polyimide, polyethylene-oxide, poly(vinylidene fluoride), rubbers, ethylene-propylene-diene monomer (EPDM), hydrophilic binders, polyvinylidene fluoride (PVDF), styrene butadiene copolymers, poly (3,4-ethylene dioxythiophene):poly (styrene sulfonate) (PEDOT:PSS), Poly(vinylidene fluoride-co-hexafluoropropylene) (PVDF-HFP), maleic anhydride-grated-polyvinylidene fluoride (MPVDF), styrene butadiene rubber (SBR), mixtures of SBR and sodium carboxymethyl cellulose (SBR+CMC), polyacrylonitrile, fluorinated polyimide, poly(3-hexylthiophene)-b-poly(ethylene oxide), poly (1-pyrenemethyl methacrylate) (PPy), poly (1-pyrenemethyl methacrylate-co-methacrylic acid) (PPy-MAA), poly (1-pyrenemethyl methacrylate-co-triethylene glycol methyl ether) (PPyE), polyacrylic acid and this lithium salt (PAA), sodium polyacrylate, fluorinated polyacrylate, polyimide (PI), polyamide imide (PAI), polyether imide (PEI), other suitable polymeric materials configured to provide sufficient mechanical support for the electrode materials, and combinations thereof. In some embodiments, the electrode materials can include between about 0.01 wt % to about 30 wt % of the binder, about 1 wt % to about 20 wt %, about 2 wt % to about 19 wt %, about 3 wt % to about 18 wt %, about 4 wt % to about 17 wt %, about 5 wt % to about 16 wt %, about 6 wt % to about 15 wt %, or about 5 wt % to about 20 wt %, inclusive of all values and ranges therebetween.

In some embodiments, the thickness of the anode 110 and/or the cathode 130 can be at least about 30 μm. In some embodiments, the anode 110 and/or the cathode 130 can include a semi-solid electrode with a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 600 μm, at least about 700 μm, at least about 800 μm, at least about 900 μm, at least about 1,000 μm, at least about 1,500 μm, and up to about 2,000 μm, inclusive of all thicknesses therebetween. In some embodiments, the thickness of the first electrode material 112 can be less than about 50% of the total thickness of the anode 110. In some embodiments, the thickness of the first electrode material 112 can be less than about 45%, less than about 40%, less than about 35%, less than about 30%, less than about 25%, less than about 20%, less than about 15%, less than about 10%, less than about 5%, or less than about 3% of the total thickness of the anode 110. In some embodiments, the thickness of the first electrode material 112 can be less than about 80 μm, less than about 70 μm, less than about 60 μm, less than about 50 μm, less than about 40 μm, less than about 30 μm, less than about 20 μm, less than about 10 μm, less than about 5 μm, less than about 2 μm, or less than about 1 μm.

In some embodiments, the thickness of the second electrode material 114 can be at least about 20% of the total thickness of the anode 110. In some embodiments, the thickness of the second electrode material 114 can be at least about 50%, at least about 60%, at least about 70%, at least about 80%, at least about 90%, at least about 95%, at least about 97%, at least about 98%, or at least about 99% of the total thickness of the anode 110. In some embodiments, the thickness of the second electrode material 114 can be at least about 30 μm. In some embodiments, the thickness of the second electrode material 114 can be at least about 50 μm, at least about 100 μm, at least about 150 μm, at least about 200 μm, at least about 250 μm, at least about 300 μm, at least about 350 μm, at least about 400 μm, at least about 450 μm, at least about 500 μm, at least about 600 μm, at least about 700 μm, at least about 800 μm, at least about 900 μm, at least about 1,000 μm, at least about 1,500 μm, and up to about 2,000 μm, inclusive of all thicknesses therebetween.

In some embodiments, the first electrode material 112 can include solid electrode materials manufactured according to conventional solid electrode manufacturing processes. In some embodiments, the solid electrode materials can be manufactured by forming a slurry that includes the active material, the conductive additive, and the binding agent dissolved or dispersed in a solvent. After the slurry is disposed to the electrode current collector or other suitable structure within the electrochemical cell, the slurry is dried (e.g., by evaporating the solvent) and calendered to a specified thickness. The manufacture of solid electrode materials can also commonly include material mixing, casting, calendering, drying, slitting, and working (bending, rolling, etc.) according to the battery architecture being built. Once the electrode materials are dried and calendered, the electrode materials can be wetted with the electrolyte (e.g., under pressure).

In some embodiments, the first electrode material 112 can include solid electrode materials manufactured by deposition processes, which includes vapor deposition, electric beam deposition, electrochemical deposition, sol-gel, sputtering, and physical spray method.

In some embodiments, the second electrode material 114 can include pure conductive agent dispersed on the first electrode material 112. Coating a conductive slurry (without any active materials) on the first electrode material 112 as an electrolyte serves as an alternative method for electrolyte ejection in traditional cell production process. The conductive agent can flow into the first electrode material 112 during the cycling, especially with the volume expansion materials, to fill in the void space. In other words, the use of a conductive agent can help maintain the electrode's electronic conductivity thereby improving cycling stability of the first electrode material 112.

In some embodiments, the second electrode material 114 can include semi-solid electrode materials. In some embodiments, semi-solid electrode materials described herein can be made: (i) thicker (e.g., greater than 250 μm-up to 2,000 μm or even greater) than solid electrode materials due to the reduced tortuosity and higher electronic conductivity of the semi-solid electrode, (ii) with higher loadings of active materials than conventional electrode materials, and (iii) with a simplified manufacturing process utilizing less equipment. These relatively thick semi-solid electrodes decrease the volume, mass and cost contributions of inactive components with respect to active components, thereby enhancing the commercial appeal of electrodes including the semi-solid electrode materials. In some embodiments, the second electrode material 114 can be disposed onto the first electrode material 112 in the absence of a drying step. Removal of the drying step can potentially reduce the processing time and cost of production. In some embodiments, the second electrode material 114 can be disposed onto a separator (not shown) and then the separator with the second electrode material 114 can be combined with the first electrode material 112 disposed on the anode current collector 120. In some embodiments, the second electrode material 114 can include a binder. In some embodiments, the second electrode material 114 can be substantially free of binder.

In some embodiments, the semi-solid electrode materials described herein can be binderless. Instead, the volume of the semi-solid electrode materials normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes.

Since the semi-solid electrode materials described herein can be made substantially thicker than conventional electrode materials, the ratio of active materials to inactive materials can be much higher. In some embodiments, this increased active to inactive material ratio can increase the overall charge capacity and energy density of a battery that includes the semi-solid electrode materials described herein.

As described herein, solid electrode materials are typically denser (having a lower porosity) while semi-solid electrode materials are typically less dense (having a higher porosity). Without wishing to be bound by any particular theory, the lower porosity of the solid electrode materials may result in a lower probability of ion conductance to available active material due to increased ionic tortuosity across the electrode thickness. In some embodiments, the first electrode material 112 can include solid electrode materials and the second electrode material 130 can include semi-solid electrode materials such that the compositional gradient across the electrode thickness includes a change in porosity. Without wishing to be bound by any particular theory, by creating a porosity gradient across the thickness of the anode 110, the total theoretical energy density of the anode 110 is higher due to the use of the conventional electrode materials and the accessibility of the conventional active material to ions remains high due to high ionic flux across the semi-solid electrode material.

In some embodiments, while the first electrode material 112 is described as including solid electrode materials and the second electrode material 114 is described as including semi-solid electrode materials, other configurations and chemistries are possible. For example, in some embodiments, the first electrode material 112 can include a semi-solid electrode material having a first composition and the second electrode material 114 can include a semi-solid electrode material having a second composition. In some embodiments, the first electrode material 112 can include a semi-solid electrode material having a first porosity and the second electrode material 114 can include a semi-solid electrode material having a second porosity greater than the first porosity. In some embodiments, the first electrode material 112 can include semi-solid electrode materials having a first ion storage capacity and the second electrode material 114 can include semi-solid electrode materials having a second ion storage capacity less than the first ion storage capacity. In some embodiments, the first electrode material 112 can include semi-solid electrode materials having a first ion conductivity and the second electrode material 114 can include semi-solid electrode materials having a second ion conductivity greater than the first ion conductivity.

In some embodiments, the first electrode material 112 can have a first porosity and the second electrode material 114 can have a second porosity less than the first porosity. In some embodiments, the second porosity can be greater than the first porosity. In some embodiments, the second porosity can be substantially equal to the first porosity.

In some embodiments, the first porosity can be less than about 3% or less than about 5%. In some embodiments, the first porosity can be between about 20% and about 25%, between about 25% and about 30%, between about 30% and about 35%, between about 35% and about 40%, between about 40% and about 45%, between about 45% and about 50%, between about 50% and about 55%, or between about 55% and about 60%.

In some embodiments, the second porosity can be between about 20% and about 25%, between about 25% and about 30%, between about 30% and about 35%, between about 35% and about 40%, between about 40% and about 45%, between about 45% and about 50%, between about 50% and about 55%, or between about 55% and about 60%.

In some embodiments, the first electrode material 112 can have a first surface area and the second electrode material 114 can have a second surface area greater than the first surface area. In some embodiments, the second surface area can be less than the first area. In some embodiments, the second surface area can be substantially equal to the first surface area.

In some embodiments, the first electrode material 112 can include active materials with a surface area less than about 1 m²/g. In some embodiments, the first electrode material 112 can include active materials with a surface area between about 1 m²/g and about 2 m²/g, between about 2 m²/g and about 3 m²/g, between about 3 m²/g and about 4 m²/g, between about 4 m²/g and about 5 m²/g, or greater than about 5 m²/g.

In some embodiments, the second electrode material 114 can include active materials with a surface area less than about 1 m²/g. In some embodiments, the second electrode material 114 can include active materials with a surface area between about 1 m²/g and about 2 m²/g, between about 2 m²/g and about 3 m²/g, between about 3 m²/g and about 4 m²/g, between about 4 m²/g and about 5 m²/g, or greater than about 5 m²/g.

In some embodiments, during operation of the electrochemical cell, ions can be shuttled through the second electrode material 114 at a first rate and into the first electrode material 112 at a second rate less than the first rate. In some embodiments, the first electrode material 112 can have a first ion storage capacity and the second electrode material 114 can have a second ion storage capacity less than the first ion storage capacity. In some embodiments, the finished electrode can have a thickness that is substantially equal to the sum of the thickness of the anode current collector 120, the first electrode material 112, and the second electrode material 114. In some embodiments, the thickness of the finished compositional gradient electrode can have a power density greater than an electrode formed from either the first electrode material 112 alone or the second electrode material 114 alone and having the same thickness as the finished compositional gradient electrode.

In some embodiments, the first electrode material 112 can include higher concentrations than the second electrode material 114 of high expansion active material in charging such as a silicon base (Si, SiO, Si-alloy) and/or a tin base (Sn, SnO, Sn-Alloy), etc.

Higher expansion active materials can transition to small particles after charging and discharging cycles due to expansion-compression forces in cycling. These forces tend to reduce the electron network during cycles, and more high expansion materials near the current collector can secure electron path. In some embodiments, having a semi-solid electrode as the second electrode materials 114 tends to absorb these expansion forces. In some embodiments, having high porosity of a high expandable active material in the first electrode materials 112 allows the semi-sold electrode with higher electron conductive network and less expandable active material in second layer move into the porous area thereby maintaining the electron network.

In some embodiments, the energy density of the anode 110 having a compositional gradient (e.g., including the first electrode material 112 and the second electrode material 114) can be greater than about 0.2 MJ/L, about 0.25 MJ/L, about 0.3 MJ/L, about 0.35 MJ/L, about 0.4 MJ/L, about 0.45 MJ/L, about 0.5 MJ/L, about 0.55 MJ/L, about 0.6 J/L, about 0.65 MJ/L, about 0.7 MJ/L, about 0.75 MJ/L, about 0.8 MJ/L, about 0.85 MJ/L, about 0.9 MJ/L, about 0.95 MJ/L, about 1.0 MJ/L, about 1.05 MJ/L, about 1.1 MJ/L, about 1.15 MJ/L, about 1.2 MJ/L, about 1.25 MJ/L, about 1.3 MJ/L, about 1.35 MJ/L, about 1.4 MJ/L, about 1.45 MJ/L, about 1.5 MJ/L, about 1.55 MJ/L, about 1.6 MJ/L, about 1.65 MJ/L, about 1.7 MJ/L, about 1.75 MJ/L, about 1.8 MJ/L, about 1.85 MJ/L, about 1.9 MJ/L, about 1.95 MJ/L, about 2.0 MJ/L, about 2.05 MJ/L, about 2.1 MJ/L, about 2.15 MJ/L, about 2.2 MJ/L, about 2.25 MJ/L, about 2.3 MJ/L, about 2.35 MJ/L, about 2.4 MJ/L, about 2.45 MJ/L, about 2.5 MJ/L, about 2.55 MJ/L, about 2.6 MJ/L, about 2.65 MJ/L, about 2.7 MJ/L, about 2.75 MJ/L, about 2.8 MJ/L, about 2.85 MJ/L, about 2.9 MJ/L, about 2.95 MJ/L, about 3.0 MJ/L, about 3.5 MJ/L, about 4.0 MJ/L, about 4.5 MJ/L, or about 5.0 MJ/L, inclusive of all values and ranges therebetween.

In some embodiments, the energy density of the first electrode material 112 can be greater than about 0.2 MJ/L, about 0.25 MJ/L, about 0.3 MJ/L, about 0.35 MJ/L, about 0.4 MJ/L, about 0.45 MJ/L, about 0.5 MJ/L, about 0.55 MJ/L, about 0.6 J/L, about 0.65 MJ/L, about 0.7 MJ/L, about 0.75 MJ/L, about 0.8 MJ/L, about 0.85 MJ/L, about 0.9 MJ/L, about 0.95 MJ/L, about 1.0 MJ/L, about 1.05 MJ/L, about 1.1 MJ/L, about 1.15 MJ/L, about 1.2 MJ/L, about 1.25 MJ/L, about 1.3 MJ/L, about 1.35 MJ/L, about 1.4 MJ/L, about 1.45 MJ/L, about 1.5 MJ/L, about 1.55 MJ/L, about 1.6 MJ/L, about 1.65 MJ/L, about 1.7 MJ/L, about 1.75 MJ/L, about 1.8 MJ/L, about 1.85 MJ/L, about 1.9 MJ/L, about 1.95 MJ/L, about 2.0 MJ/L, about 2.05 MJ/L, about 2.1 MJ/L, about 2.15 MJ/L, about 2.2 MJ/L, about 2.25 MJ/L, about 2.3 MJ/L, about 2.35 MJ/L, about 2.4 MJ/L, about 2.45 MJ/L, about 2.5 MJ/L, about 2.55 MJ/L, about 2.6 MJ/L, about 2.65 MJ/L, about 2.7 MJ/L, about 2.75 MJ/L, about 2.8 MJ/L, about 2.85 MJ/L, about 2.9 MJ/L, about 2.95 MJ/L, about 3.0 MJ/L, about 3.5 MJ/L, about 4.0 MJ/L, about 4.5 MJ/L, or about 5.0 MJ/L, inclusive of all values and ranges therebetween.

In some embodiments, the energy density of the second electrode material 114 can be greater than about 0.2 MJ/L, about 0.25 MJ/L, about 0.3 MJ/L, about 0.35 MJ/L, about 0.4 MJ/L, about 0.45 MJ/L, about 0.5 MJ/L, about 0.55 MJ/L, about 0.6 J/L, about 0.65 MJ/L, about 0.7 MJ/L, about 0.75 MJ/L, about 0.8 MJ/L, about 0.85 MJ/L, about 0.9 MJ/L, about 0.95 MJ/L, about 1.0 MJ/L, about 1.05 MJ/L, about 1.1 MJ/L, about 1.15 MJ/L, about 1.2 MJ/L, about 1.25 MJ/L, about 1.3 MJ/L, about 1.35 MJ/L, about 1.4 MJ/L, about 1.45 MJ/L, about 1.5 MJ/L, about 1.55 MJ/L, about 1.6 MJ/L, about 1.65 MJ/L, about 1.7 MJ/L, about 1.75 MJ/L, about 1.8 MJ/L, about 1.85 MJ/L, about 1.9 MJ/L, about 1.95 MJ/L, about 2.0 MJ/L, about 2.05 MJ/L, about 2.1 MJ/L, about 2.15 MJ/L, about 2.2 MJ/L, about 2.25 MJ/L, about 2.3 MJ/L, about 2.35 MJ/L, about 2.4 MJ/L, about 2.45 MJ/L, about 2.5 MJ/L, about 2.55 MJ/L, about 2.6 MJ/L, about 2.65 MJ/L, about 2.7 MJ/L, about 2.75 MJ/L, about 2.8 MJ/L, about 2.85 MJ/L, about 2.9 MJ/L, about 2.95 MJ/L, about 3.0 MJ/L, about 3.5 MJ/L, about 4.0 MJ/L, about 4.5 MJ/L, or about 5.0 MJ/L, inclusive of all values and ranges therebetween.

In some embodiments, the specific energy of the anode 110 having a compositional gradient (e.g., including the first electrode material 112 and the second electrode material 114) can be greater than about 0.2 MJ/kg, about 0.25 MJ/kg, about 0.3 MJ/kg, about 0.35 MJ/kg, about 0.4 MJ/kg, about 0.45 MJ/kg, about 0.5 MJ/kg, about 0.55 MJ/kg, about 0.6 J/kg, about 0.65 MJ/kg, about 0.7 MJ/kg, about 0.75 MJ/kg, about 0.8 MJ/kg, about 0.85 MJ/kg, about 0.9 MJ/kg, about 0.95 MJ/kg, about 1.0 MJ/kg, about 1.05 MJ/kg, about 1.1 MJ/kg, about 1.15 MJ/kg, about 1.2 MJ/kg, about 1.25 MJ/kg, about 1.3 MJ/kg, about 1.35 MJ/kg, about 1.4 MJ/kg, about 1.45 MJ/kg, or about 1.5 MJ/kg, inclusive of all values and ranges therebetween.

In some embodiments, the specific energy of the first electrode material 112 can be greater than about 0.2 MJ/kg, about 0.25 MJ/kg, about 0.3 MJ/kg, about 0.35 MJ/kg, about 0.4 MJ/kg, about 0.45 MJ/kg, about 0.5 MJ/kg, about 0.55 MJ/kg, about 0.6 J/kg, about 0.65 MJ/kg, about 0.7 MJ/kg, about 0.75 MJ/kg, about 0.8 MJ/kg, about 0.85 MJ/kg, about 0.9 MJ/kg, about 0.95 MJ/kg, about 1.0 MJ/kg, about 1.05 MJ/kg, about 1.1 MJ/kg, about 1.15 MJ/kg, about 1.2 MJ/kg, about 1.25 MJ/kg, about 1.3 MJ/kg, about 1.35 MJ/kg, about 1.4 MJ/kg, about 1.45 MJ/kg, or about 1.5 MJ/kg, inclusive of all values and ranges therebetween.

In some embodiments, the specific energy of the second electrode material 114 can be greater than about 0.2 MJ/kg, about 0.25 MJ/kg, about 0.3 MJ/kg, about 0.35 MJ/kg, about 0.4 MJ/kg, about 0.45 MJ/kg, about 0.5 MJ/kg, about 0.55 MJ/kg, about 0.6 J/kg, about 0.65 MJ/kg, about 0.7 MJ/kg, about 0.75 MJ/kg, about 0.8 MJ/kg, about 0.85 MJ/kg, about 0.9 MJ/kg, about 0.95 MJ/kg, about 1.0 MJ/kg, about 1.05 MJ/kg, about 1.1 MJ/kg, about 1.15 MJ/kg, about 1.2 MJ/kg, about 1.25 MJ/kg, about 1.3 MJ/kg, about 1.35 MJ/kg, about 1.4 MJ/kg, about 1.45 MJ/kg, or about 1.5 MJ/kg, inclusive of all values and ranges therebetween.

In some embodiments, the first electrode material 112 can include about 10%, about 20%, about 30%, about 40%, about 50%, about 60%, about 70%, about 80%, about 90%, or about 100% by volume of a high-capacity anode material. In some embodiments, the second electrode material 114 can include a high-capacity anode material combined with carbon, graphite, or other active materials with or without a binder. In some embodiments, the second electrode material 114 can include less than about 60%, less than about 55%, less than about 50%, less than about 45%, less than about 40%, less than about 35%, less than about 30%, less than about 25%, less than about 20%, less than about 15%, less than about 10%, or less than about 5% by volume of high-capacity anode material. In some embodiments, the second electrode material 114 can be substantially free of high-capacity material.

As described above, the anode 110 includes layers of two different anode materials. In some embodiments, the cathode 130 can alternatively include layers of two or more different cathode materials. In some embodiments, the first electrode material 112 and/or second electrode material 114 can include any material that can be used as a cathode in a lithium-ion battery. Examples of cathode materials that can be used in an electrochemical cell are described the ′159 patent incorporated by reference above.

In some embodiments, the volume percentage of the high-capacity anode material in the second electrode material 114 can be about 10-80% less that the volume percentage of the high-capacity anode material in the first electrode material 112.

In some embodiments, the cycle life of the finished anode 110 having a compositional gradient (e.g., including the first electrode material 112 and the second electrode material 114) can be greater than about 200 charge/discharge cycles, greater than about 250 cycles, greater than about 300 cycles, greater than about 350 cycles, greater than about 400 cycles, greater than about 450 cycles, greater than about 500 cycles, greater than about 550 cycles, greater than about 600 cycles, greater than about 650 cycles, greater than about 700 cycles, greater than about 750 cycles, greater than about 800 cycles, greater than about 850 cycles, greater than about 900 cycles, greater than about 950 cycles, greater than about 1,000 cycles, greater than about 1,050 cycles, greater than about 1,100 cycles, greater than about 1,250 cycles, greater than about 1,300 cycles, greater than about 1,350 cycles, greater than about 1,400 cycles, greater than about 1,450 cycles, greater than about 1,500 cycles, greater than about 1,550 cycles, greater than about 1,600 cycles, greater than about 1,650 cycles, greater than about 1,700 cycles, greater than about 1,750 cycles, greater than about 1,800 cycles, greater than about 1,850 cycles, greater than about 1,900 cycles, greater than about 1,950 cycles, greater than about 2,000 cycles, greater than about 2,500 cycles, greater than about 3,000 cycles, greater than about 5,000 cycles, or greater than about 10,000 cycles.

In some embodiments, the charge rate of an electrochemical cell including an electrode having a compositional gradient (e.g., including the first electrode material 112 and the second electrode material 114) can be less than about 5 hours per 100 g of electrode material at a rate of 1 C, less than about 4.5 hours, less than about 3 hours, less than about 3 hours, less than about 2.5 hours, less than about 2 hours, less than about 1.5 hours, or less than about 1 hour, inclusive of all values and ranges therebetween. In some embodiments, having a semi-solid electrode second electrode material 114 and a conventional (i.e., “dry”) first electrode material 112 can avoid the electrolyte filling process, which is usually the last step in conventional battery manufacturing processes. This can also lead to higher loading in the first electrode material 112 by allowing the electrolyte present in the second electrode material 114 to saturate the first electrode material 112.

Typically, the cathode current collector 140 in a cathode used in lithium-ion batteries is made from aluminum coated with conductive carbon. The conductive carbon coating can improve electrical conductivity and increase the mechanical strength of the cathode current collector 140, thereby reducing the possibility of cracking of the cathode current collector 140. In some embodiments, the cathode 130 can have a first cathode material and a second cathode material (not shown). In some embodiments, the first cathode material can be disposed on a bare aluminum current collector in place of the conductive carbon layer. In some embodiments, the first cathode material can be manufactured and/or deposited via the same methods as in the anode 110, as described above. In some embodiments, the first cathode material can have a thickness that is the same or similar to the thickness of the first electrode material 112 of the anode 110, as described above. In some embodiments, the second cathode material can be a semi-solid cathode and can be deposited via the same methods as in the anode, as described above. In some embodiments, the second cathode material can have a thickness similar to the thickness of the second electrode material 114 of the anode, as described above.

In some embodiments, the cathode 130 can include semi-solid electrode materials, the same or substantially similar to those described in the ′159 patent. In some embodiments, the cathode 130 can be a conventional cathode (e.g., a solid cathode). In some embodiments, the cathode 130 can include an olivine based electrode. In some embodiments, the anode 110 can have a flat or substantially flat voltage profile near 100% state-of-charge (SOC). In some embodiments, the cathode 130 can have a flat or substantially flat voltage profile near 100% state-of-charge (SOC). In some embodiments, the use of a flat voltage layer on top of Lithium Nickel Manganese Cobalt Oxide (NMC) material can reduce overpotential of the NMC material.

In some embodiments, the cathode 130 can have a thickness of at least about 30 μm. In some embodiments, the cathode 130 can include a semi-solid electrode with a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 600 μm, at least about 700 μm, at least about 800 μm, at least about 900 μm, at least about 1,000 μm, at least about 1,500 μm, and up to about 2,000 μm, inclusive of all thicknesses therebetween.

In some embodiments, the cathode 130 can have a porosity of less than about 3% or less than about 5%. In some embodiments, the cathode 130 can have a porosity between about 20% and about 25%, between about 25% and about 30%, between about 30% and about 35%, between about 35% and about 40%, between about 40% and about 45%, between about 45% and about 50%, between about 50% and about 55%, or between about 55% and about 60%.

In some embodiments, the cathode 130 can be an NMC cathode. In some embodiments, the cathode 130 can be an NMC semi-solid cathode. In some embodiments, the cathode 130 can include a lithium manganese iron phosphate (LMFP) electrode.

In some embodiments, the separator 150 can include polypropylene, polyethylene, a cellulosic-material, any other suitable polymeric material, or combinations thereof. In some embodiments, the separator 150 can be an ion-permeable membrane separator, the same or substantially similar to those described in the ′701 publication. In some embodiments, the separator 150 can be a conventional separator.

As shown, the coating layer 155 is disposed on a side of the separator 150 adjacent to the anode 110 (i.e., the anode side). In some embodiments, the coating layer 155 can be disposed on a side of the separator 150 adjacent to the cathode 130 (i.e., the cathode side). In some embodiments, the coating layer 155 can be disposed on both the anode side and the cathode side of the separator 150. In some embodiments, the coating layer 155 can include hard carbon, soft carbon, amorphous carbon, a graphitic hard carbon mixture, or any combination thereof. In some embodiments, the coating layer 155 can include active materials. In some embodiments, the coating layer 155 can include NMC. In some embodiments, the coating layer 155 can include lithium manganese iron phosphate (LMFP). In some embodiments, the coating layer 155 can include lithium iron phosphate (LFP). In some embodiments, the coating layer 155 can include lithium manganese oxide (LMO). In some embodiments, the coating layer 155 can include lithium nickel dioxide (LNO) doped with manganese. In some embodiments, including LMFP in the coating layer 155 can give way to a high voltage on a surface of an NMC electrode adjacent to the coating layer 155 and can prevent overpotential losses in the NMC material.

Binder in the coating layer 155 can interfere with diffusion of ions (e.g., lithium ions) and increase tortuosity in the coating layer 155. In some embodiments, the coating layer 155 can be free or substantially free of binder. In some embodiments, the coating layer 155 can include less than about 5 vol %, less than about 4 vol %, less than about 3 vol %, less than about 2 vol %, or less than about 1 vol % binder.

In some embodiments, the coating layer 155 can act as a physical barrier to the movement of electroactive species. In some embodiments, the coating layer 155 can react chemically with electroactive species. In some embodiments, the coating layer 155 can act as an electrochemical storage medium. In some embodiments, the use of a semi-solid electrode material in the second electrode material 114 adjacent to the coating layer can have reduced overpotential losses, as compared to the use of a conventional electrode material in the second electrode material 114. Conventional electrode materials are often mixed with binders, dried and calendered. Binders can collect at the interface between the second electrode material 114 and the coating layer 155. This can cause inefficiencies in ion transfer between the second electrode material 114 and the coating layer 155. In some embodiments, the coating layer 155 can include a higher voltage material than the electrode adjacent to the coating material 155, such that dendrite formation can be prevented. For example, if the coating layer 155 is disposed adjacent to the anode 110 and the anode 110 is composed of graphite, then the coating layer 155 can include a higher voltage material than graphite. Inclusion of a higher voltage material in the coating layer 155 can draw ions toward the coating layer 155 to prevent them from forming dendrites and potentially causing short circuit events. Using a semi-solid electrode material (e.g., the semi-solid electrode materials described in the ′159 patent) can prevent this buildup of binder material at the interface between the electrode material 114 and the coating layer 155. This reduced buildup can reduce overpotential losses in the electrochemical cell 100.

In some embodiments, incorporation of the coating layer 155 can improve charge rate of the electrochemical cell 100 disproportionately to any changes to the discharge rate of the electrochemical cell 100. In some embodiments, the incorporation of the coating layer 155 can improve the charge rate of the electrochemical cell 100 without significantly changing the discharge rate of the electrochemical cell 100. In some embodiments, the incorporation of the coating layer 155 can improve the discharge rate of the electrochemical cell 100 without significantly changing the charge rate of the electrochemical cell 100. An example of disproportional charging and discharging can be found in laptop batteries, which often discharge over a period of about 6-8 hours (i.e., a discharge rate of about C/8-C/6), but charge over a period of about 1 hour (i.e., a charge rate of about 1 C). In some embodiments, the electrochemical cell 100 can obtain the same or a substantially similar discharge capacity to its charge capacity when discharged at a lower rate than the charging rate of the electrochemical cell 100. In some embodiments, the electrochemical cell 100 can obtain the same or a substantially similar discharge capacity to its charge capacity when discharged at a higher rate than the charging rate of the electrochemical cell 100.

In some embodiments, the electrochemical cell 100 can be charged at a C-rate of at least about C/10, at least about C/9, at least about C/8, at least about C/7, at least about C/6, at least about C/5, at least about C/4, at least about C/3, at least about C/2, at least about 1 C, at least about 2C, at least about 3C, at least about 4 C, at least about 5C, at least about 6C, at least about 7C, at least about 8C, or at least about 9 C. In some embodiments, the electrochemical cell 100 can be charged at a C-rate of no more than about 10C, no more than about 9C, no more than about 8C, no more than about 7C, no more than about 6C, no more than about 5C, no more than about 4 C, no more than about 3C, no more than about 2C, no more than about 1 C, no more than about C/2, no more than about C/3, no more than about C/4, no more than about C/5, no more than about C/6, no more than about C/7, no more than about C/8, or no more than about C/9. Combinations of the above-referenced C-rates for charging are also possible (e.g., at least about C/10 and no more than about 1° C. or at least about C/5 and no more than about 1 C), inclusive of all values and ranges therebetween. In some embodiments, the electrochemical cell 100 can be charged at a C-rate of about C/10, about C/9, about C/8, about C/7, about C/6, about C/5, about C/4, about C/3, about C/2, about 1 C, about 2C, about 3 C, about 4 C, about 5C, about 6C, about 7C, about 8C, about 9C, or about 10 C.

In some embodiments, the electrochemical cell 100 can be discharged at a C-rate of at least about C/20, at least about C/19, at least about C/18, at least about C/17, at least about C/16, at least about C/15, at least about C/14, at least about C/13, at least about C/12, at least about C/11, at least about C/10, at least about C/9, at least about C/8, at least about C/7, at least about C/6, at least about C/5, at least about C/4, at least about C/3, at least about C/2, at least about 1 C, at least about 2C, at least about 3C, or at least about 4 C. In some embodiments, the electrochemical cell 100 can be discharged at a C-rate of no more than about 5C, no more than about 4 C, no more than about 3C, no more than about 2C, no more than about 1 C, no more than about C/2, no more than about C/3, no more than about C/4, no more than about C/5, no more than about C/6, no more than about C/7, no more than about C/8, no more than about C/9, no more than about C/10, no more than about C/11, no more than about C/12, no more than about C/13, no more than about C/14, no more than about C/15, no more than about C/16, no more than about C/17, no more than about C/18, or no more than about C/19. Combinations of the above-referenced C-rates for discharging are also possible (e.g., at least about C/20 and no more than about 5 C or at least about C/5 and no more than about 1 C), inclusive of all values and ranges therebetween. In some embodiments, the electrochemical cell 100 can be discharged at a C-rate of about C/20, about C/19, about C/18, about C/17, about C/16, about C/15, about C/14, about C/13, about C/12, about C/11, about C/10, about C/9, about C/8, about C/7, about C/6, about C/5, about C/4, about C/3, about C/2, about 1 C, about 2C, about 3 C, about 4 C, or about 5 C.

In some embodiments, when disposed on the anode side of the separator 150, the coating layer 155 can have a thickness of at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, or at least about 19 μm. In some embodiments, when disposed on the anode side of the separator 150, the coating layer 155 can have a thickness of no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, or no more than about 200 nm. Combinations of the above-referenced thicknesses of the coating layer 155 are also possible (e.g., at least about 100 nm and no more than about 20 μm or at least about 1 μm and no more than about 5 μm), inclusive of all values and ranges therebetween. In some embodiments, when disposed on the anode side of the separator 150, the coating layer 155 can have a thickness of at about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm.

In some embodiments, when disposed on the cathode side of the separator 150, the coating layer 155 can have a thickness of at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 1.1 μm, at least about 1.2 μm, at least about 1.3 μm, at least about 1.4 μm, at least about 1.5 μm, at least about 1.6 μm, at least about 1.7 μm, at least about 1.8 μm, or at least about 1.9 μm. In some embodiments, when disposed on the cathode side of the separator 150, the coating layer 155 can have a thickness of no more than about 2 μm, no more than about 1.9 μm, no more than about 1.8 μm, no more than about 1.7 μm, no more than about 1.6 μm, no more than about 1.5 μm, no more than about 1.4 μm, no more than about 1.3 μm, no more than about 1.2 μm, no more than about 1.1 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, or no more than about 20 nm. Combinations of the above-referenced thicknesses of the coating layer 155 are also possible (e.g., at least about 10 nm and no more than about 2 μm or at least about 200 nm and no more than about 1.5 μm), inclusive of all values and ranges therebetween. In some embodiments, when disposed on the cathode side of the separator 150, the coating layer 155 can have a thickness of about 10 nm, at about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 1.1 μm, about 1.2 μm, about 1.3 μm, about 1.4 μm, about 1.5 μm, about 1.6 μm, about 1.7 μm, about 1.8 μm, about 1.9 μm, or about 2 μm.

In some embodiments, the coating layer 155 can have a density of at least about 1.2 g/cc, at least about 1.3 g/cc, at least about 1.4 g/cc, at least about 1.5 g/cc, at least about 1.6 g/cc, at least about 1.7 g/cc, at least about 1.8 g/cc, or at least about 1.9 g/cc. In some embodiments, the coating layer 155 can have a density of no more than about 2 g/cc, no more than about 1.9 g/cc, no more than about 1.8 g/cc, no more than about 1.7 g/cc, no more than about 1.6 g/cc, no more than about 1.5 g/cc, no more than about 1.4 g/cc, or no more than about 1.3 g/cc. Combinations of the above-referenced densities of the coating layer 155 are also possible (e.g., at least about 1.2 g/cc and no more than about 2 g/cc or at least about 1.3 g/cc and no more than about 2 g/cc), inclusive of all values and ranges therebetween. In some embodiments, the coating layer 155 can have a density of about 1.2 g/cc, about 1.3 g/cc, about 1.4 g/cc, about 1.5 g/cc, about 1.6 g/cc, about 1.7 g/cc, about 1.8 g/cc, about 1.9 g/cc, or about 2 g/cc.

In some embodiments, the coating layer 155 can include particles with an average particle size (i.e., D50) of at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, or at least about 19 μm. In some embodiments, the coating layer 155 can include particles with an average particle size of no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, or no more than about 20 nm.

Combinations of the above-referenced particle sizes are also possible (e.g., at least about 10 nm and no more than about 20 μm or at least about 1 μm and no more than about 5 μm), inclusive of all values and ranges therebetween. In some embodiments, the coating layer 155 can include particles with an average particle size of about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, or about 19 μm, or about 20 μm.

In some embodiments, the coating layer 155 can have a particle loading density of at least about 20 vol %, at least about 25 vol %, at least about 30 vol %, at least about 35 vol %, at least about 40 vol %, at least about 45 vol %, at least about 50 vol %, at least about 55 vol %, at least about 60 vol %, at least about 65 vol %, at least about 70 vol %, at least about 75 vol %, at least about 80 vol %, or at least about 85 vol %. In some embodiments, the coating layer 155 can have a particle loading density of no more than about 90 vol %, no more than about 85 vol %, no more than about 80 vol %, no more than about 75 vol %, no more than about 70 vol %, no more than about 65 vol %, no more than about 60 vol %, no more than about 55 vol %, no more than about 50 vol %, no more than about 45 vol %, no more than about 40 vol %, no more than about 35 vol %, no more than about 30 vol %, or no more than about 25 vol %. Combinations of the above-referenced particle loading densities are also possible (e.g., at least about 20 vol % and no more than about 90 vol % or at least about 30 vol % and no more than about 60 vol %), inclusive of all values and ranges therebetween. In some embodiments, the coating layer 155 can have a particle loading density of about 20 vol %, about 25 vol %, about 30 vol %, about 35 vol %, about 40 vol %, about 45 vol %, about 50 vol %, about 55 vol %, about 60 vol %, about 65 vol %, about 70 vol %, about 75 vol %, about 80 vol %, about 85 vol %, or about 90 vol %.

In some embodiments, the coating layer 155 can be applied to the separator 150 via a vapor deposition process, chemical vapor deposition, physical vapor deposition, atomic layer deposition, transfer film deposition, slot die coating, gravure coating, metal-organic chemical vapor deposition, nitrogen-plasma assisted deposition, sputter deposition, reactive sputter deposition, spattering, melt quenching, mechanical milling, spraying, a cold spray process, a plasma deposition process, electrochemical deposition, a sol-gel process, or any combination thereof. In some embodiments, the coating layer 155 can be applied to the separator 150 via a liquid coating process, an extrusion process with or without a hot/cold press process. In some embodiments, the coating layer 155 can be applied to the separator via casting, caledering, drop coating, pressing, roll pressing, calendering, tape casting, or any combination thereof. In some embodiments, the coating layer 155 can be applied to the separator 150 via any of the methods described in the ′351 publication and/or the ′705 publication.

As shown, the anode 110 includes a first electrode material 112 and a second electrode material 114. In some embodiments, the anode 110 can include a single electrode material. In other words, the anode 110 can be a single layer of electrode material. In some embodiments, the anode 110 can be a semi-solid electrode. In some embodiments, the anode 110 can be a conventional electrode. In some embodiments, the anode 110 can be a solid electrode. In some embodiments, the anode 110 can be a graphite electrode. In some embodiments, the anode 110 can be a semi-solid graphite electrode.

In some embodiments, the cathode 130 can include a single electrode material. In other words, the cathode 130 can be a single layer of electrode material. In some embodiments, the cathode 130 can be a semi-solid electrode. In some embodiments, the cathode 130 can be a conventional electrode. In some embodiments, the cathode 130 can be a solid electrode. In some embodiments, the cathode 110 can include NMC 811.

### Pre-Lithiation

Many electrodes, e.g., lithium-ion electrodes, and particularly anodes, can suffer from irreversible capacity loss at the battery formation stage (i.e., the initial cycling step which includes charging and discharging of the electrochemical cell that includes the electrodes). Irreversible capacity loss can occur due to consumption of lithium ions from the cathode active material by the anode, which uses those lithium ions in the formation of the solid-electrolyte interface (SEI) layer. This quantity of consumed lithium becomes unavailable for subsequent use in electric charge storage, and therefore represents an undesirable and irreversible capacity loss. Moreover, this irreversible capacity loss can be accompanied by volumetric expansion of the anode due to the lithium ions being irreversibly trapped in the anode material. This volumetric expansion problem is exacerbated in semi-solid anodes that include high-capacity anode materials (e.g., silicon or tin) in the semi-solid anode formulation, since high-capacity anode materials are capable of incorporating a larger amount of lithium (and enable higher energy cell designs), as compared with conventional materials such as graphite. For example, while graphite can incorporate about 1 lithium atom for every 6 carbon atoms, silicon can theoretically incorporate about 4.4 lithium atoms for every silicon atom.

This higher capacity can allow the formation of electrochemical cells with much higher charge capacity per unit area relative to conventional electrochemical cells, however the higher number of lithium ions incorporated also implies that the semi-solid anodes that include high-capacity materials consume more of the lithium from the cathode to form the SEI layer, leading to an even higher magnitude of the irreversible capacity. Furthermore, silicon experiences substantial volumetric expansion due to the incorporation of the lithium ions into the silicon atoms. The repeated volume changes (i.e., expansion and/or contraction) can negatively impact the charge capacity, and cause irreversible mechanical damage which can reduce the life of the electrochemical cell. Further descriptions of the effects of lithiation on stress and morphology of silicon electrodes can be found in “In situ Measurements of Stress Evolution in Silicon Thin Films During Electrochemical Lithiation and Delithiation,” by V. Sethuraman, et al., Journal of Power Sources 195 (2010) 5062-5066, the contents of which are hereby incorporated by reference in their entirety.

In some embodiments, the electrodes described herein can be pre-lithiated electrodes, e.g., pre-lithiated during the mixing of the semi-solid electrode material or pre-lithiated during the assembly of the electrode. In some embodiments, such pre-lithiation may help form the SEI layer in the electrode before electrochemical cell formation and before the first charge/discharge cycle is completed. In some embodiments, pre-lithiation of the electrode can be pre-lithiation of the anode. In some embodiments, pre-lithiation can be carried out by disposing a lithium-containing material into the anode such that lithium ions are stored by the anode active material more readily and earlier in the battery formation process.

In some embodiments, addition of a coating layer on the separator can cause greater initial capacity loss during first cycle. This can be caused by additional sites, into which electroactive species can migrate during the initial cycle. Pre-lithiation of the electrochemical cell can help mitigate initial capacity loss.

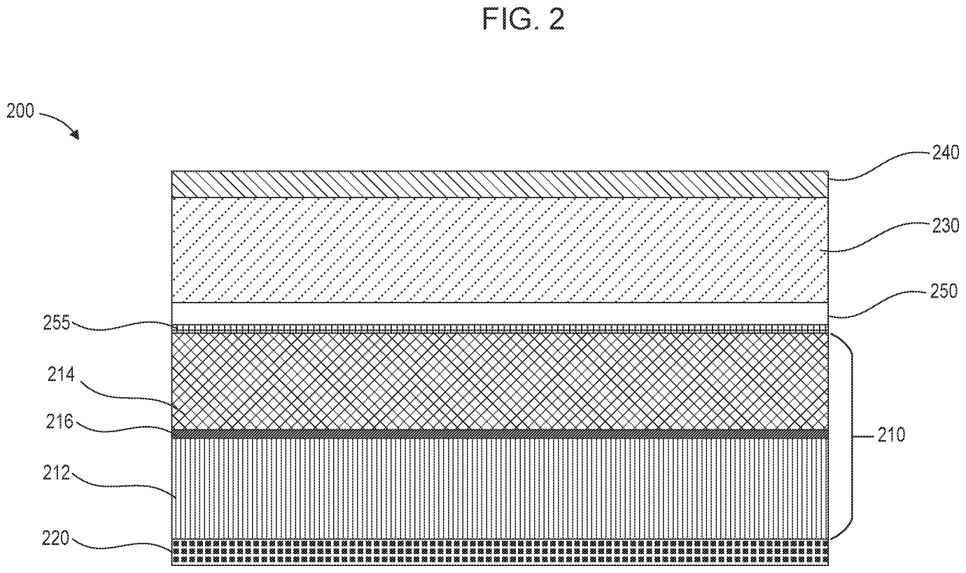

FIG. 2 is a schematic illustration of an electrochemical cell 200, including an anode 210 disposed on an anode current collector 220. The anode 210 includes a first electrode material 212, a second electrode material 214, and a lithium-containing material 216. The electrochemical cell 200 further includes a cathode 230 disposed on a cathode current collector 240 and a separator 250 disposed between the anode 210 and the cathode 230. A coating layer 255 is disposed on the separator 250.

In some embodiments, the anode 210, the first electrode material 212, the second electrode material 214, the anode current collector 220, the cathode 230, the cathode current collector 240, the separator 250, and the coating layer 255 can be the same or substantially similar to the anode 110, the first electrode material 112, the second electrode material 114, the anode current collector 120, the cathode 130, the cathode current collector 140, the separator 150, and the coating layer 155. Thus, certain aspects of the anode 210, the first electrode material 212, the second electrode material 214, the anode current collector 220, the cathode 230, the cathode current collector 240, the separator 250, and the coating layer 255 are not described in greater detail herein.

In some embodiments, the electrode materials described herein can be pre-lithiated with the lithium-containing material 216 during the preparation of the anode 210 and before formation of an electrochemical cell 200, thereby overcoming, at least in part, the irreversible capacity loss and volumetric expansion problems discussed above. The semi-solid electrode materials described herein allow the mixing of the lithium-containing material into the semi-solid electrode materials. Without wishing to be bound by any particular theory, this may be possible because the semi-solid electrode materials described herein includes the electrolyte mixed into the semi-solid electrode composition. The electrolyte provides a medium for lithium ions provided by the lithium-containing material 216 to interact with the active materials included in the semi-solid electrode materials, particularly the active materials (e.g., graphite) or high-capacity materials (e.g., silicon or tin) included in semi-solid anode materials. This allows the SEI layer to form during the mixing step such that when such the anode 210 is paired with a second electrode (not shown; e.g., a cathode) in an electrochemical cell, the lithium ions from the second electrode are not used to form the SEI layer in the anode 210. Said another way, because of pre-lithiation, the lithium ions from the second electrode (e.g., cathode) do not contribute to irreversible capacity loss at the anode 210. In some embodiments, because the lithium ions from the second electrode do not contribute to irreversible capacity loss at the anode 210, this may allow the cathode 230 to maintain its initial capacity after electrochemical cell formation. Moreover, the electrolyte included in the anode 210 may also protect the lithium-containing material 216 from the ambient environment (e.g., moisture or humidity of the ambient environment) and thereby, allows the lithium-containing material 216 to remain stable during the mixing process.

In some embodiments, pre-lithiation can be carried out by disposing the lithium-containing material 216 into the anode 210 at some point during manufacturing of the anode 210. In some embodiments, the lithium-containing material 216 can be disposed between the first electrode material 212 and the second electrode material 214. In some embodiments, the lithium-containing material 216 can be disposed between the anode current collector 220 and the first electrode material 212. In some embodiments, the lithium-containing material 216 can be disposed between the second electrode material 214 and a subsequently disposed electrode material layer (not shown). In some embodiments, the lithium-containing material 216 can be disposed between the second electrode material 214 and the separator 250.

In some embodiments, the lithium-containing material 216 can be formed according to any suitable form factor, including but not limited to, a sheet, a slurry, a suspension, a plurality of particles, a powder, an alloy solution, and combinations thereof.

In some embodiments, the lithium-containing material 216 can include a lithium metal and a binder. In some embodiments, the lithium-containing material 216 can additionally include a carbonaceous (e.g., graphitic) material. In some embodiments, the lithium-containing material 216 can initially include a solvent that is removed during drying of the electrode materials.

Another advantage provided by pre-lithiation of the semi-solid electrodes described herein is that the anode can be pre-lithiated such that it is completely charged before it is paired with a cathode. This enables the use of cathodes that do not include any available lithium for forming the SEI layer in the anode. Thus, carbon based anode materials can be used instead of lithium metal leading to better cycle stability and safety. Furthermore, intercalation of the lithium ions into high-capacity materials included in the anode can also occur during the mixing step, which allows any expansion of the high-capacity material to occur during the mixing step. Said another way, the pre-lithiation can pre-expand the semi-solid anode such that the semi-solid anode experiences less expansion during electrochemical cell formation and subsequent charge/discharge cycles. In this manner, any physical damage to the electrochemical cell due to the semi-solid anode expansion is substantially reduced or in certain cases possibly eliminated. Thus, electrochemical cells that include such pre-lithiated semi-solid anodes can have substantially higher mechanical stability and longer life compared to anodes (e.g., semi-solid anodes) that are not pre-lithiated.

In some embodiments, additional electrolyte can be added after or during the pre-lithiation processes. In pre-lithiation, the electrolyte is consumed to create SEI, and additional electrolyte will reduce the electrode without electrolyte locally in the electrode.

Additional examples of devices, methods, and systems for the pre-lithiation of electrodes can be found in U.S. Patent Publication No. 2016/0126543 (“the ′543 publication”), filed Nov. 3, 2015, entitled “Pre-Lithiation of Electrode Materials in a Semi-Solid Electrode,” the entire disclosure of which is incorporated herein by reference.

As shown, the anode 210 is depicted as a multi-layered electrode with a lithium-containing material. In some embodiments, the cathode 230 can be a multi-layered electrode with a lithium-containing material.

### High-Capacity Materials

In some embodiments, higher energy densities and capacities can be achieved by, for example, improvements in the materials used in the anode and/or cathode, and/or increasing the thickness of the anode/cathode (i.e., higher ratio of active materials to inactive materials). One of the latest materials used in the anode for consumer electronics is, for example, silicon (Si), tin (Sn), silicon alloys, or tin alloys due to their high capacity and low voltage. Typically, this high-capacity active material is mixed with graphite due to its high first charge capacity and related first charge irreversible capacity. Silicon has a first charge theoretical capacity of 4,200 mAh/g and an irreversible capacity of more than 300 mAh/g. Therefore, typical anodes that utilize Si contain a mixture of silicon and graphite in order to reduce the irreversible capacity. In addition, silicon undergoes a very large volume change during lithium insertion causing the volume of the material to grow by more than 300%. To limit this large volumetric expansion, current high-capacity anodes utilize between 10-20% silicon in the anode mixture resulting in anodes with overall capacity of about 700 to about 4,200 mAh/g.

Conventional cathode compositions have capacities of approximately 150-200 mAh/g and cannot be made thicker than 200 μm because conventional electrodes manufactured using the high speed roll-to-roll calendering process tend to delaminate from the flat current collectors if they are made thicker than about 200 μm. Additionally, thicker electrodes have higher cell impedance, which reduces energy efficiency (e.g., as described in Yu et al “Effect of electrode parameters on LiFePO₄ cathodes”, J. Electrochem. Soc. Vol. 153, A835-A839 (2006)). Therefore, to match the high-capacity anodes with the conventional cathodes, current state-of-the-art batteries have focused on reducing the thickness of the anode. For example, anodes having a thickness of about 40-50 μm and even thinner are being developed. Such thin coatings of these anode materials begin to approach the thickness level of a single graphite particle. The limitation of thickness and associated loading density in conventional coating processes has prevented development of batteries that take full advantage of the high capacity that is available in high energy anodes.

When high-capacity materials are incorporated, e.g., into the anode 110 or the anode 210, the related swelling during operation can cause damage to the electrode and to the electrochemical cell comprised therefrom. However, a surprising and unexpected outcome of using the semi-solid electrode materials described herein alongside high-capacity materials in the electrode is that the electrode experiences less damage due to the swelling of the high-capacity materials.

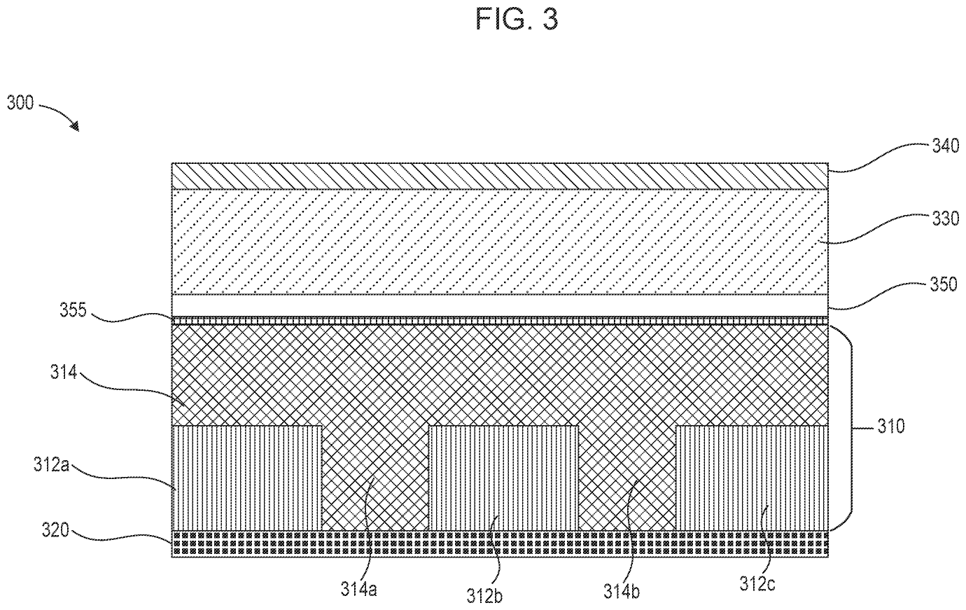

FIG. 3 is a side-view illustration of an electrochemical cell 300. The electrochemical cell 300 includes an anode 310 with a first electrode material 312 disposed on an anode current collector in sections 312a, 312b, 312c, and a second electrode material 314 disposed on the first electrode material 312. The electrochemical cell 300 further includes a cathode 330 disposed on a cathode current collector 340 and a separator 350 disposed between the anode 310 and the cathode 330. A coating layer 355 is disposed on the separator 350.

In some embodiments, the anode 310, the first electrode material 312, the second electrode material 314, the anode current collector 320, the cathode 330, the cathode current collector 340, the separator 350, and the coating layer 355 can be the same or substantially similar to the anode 110, the first electrode material 112, the second electrode material 114, the anode current collector 120, the cathode 130, the cathode current collector 140, the separator 150, and the coating layer 155. Thus, certain aspects of the anode 310, the first electrode material 312, the second electrode material 314, the anode current collector 320, the cathode 330, the cathode current collector 340, the separator 350, and the coating layer 355 are not described in further detail herein.

In some embodiments, the first electrode material 312 and/or the second electrode material 314 can include at least one of solid electrode materials, semi-solid electrode materials, high-capacity materials, and combinations thereof (collectively “electrode materials”). In some embodiments, a portion of the first electrode material 312 can be removed (e.g., by laser ablation) to expose a portion of the anode current collector 320. In some embodiments, the removal of a portion of the first electrode material 312 can form a plurality of expansion areas 314a, 314b. In some embodiments, when the second electrode material 314 is disposed onto the first electrode material 312, at least a portion of the second electrode material 314 can be interposed within the plurality of expansion areas 314a, 314b. In some embodiments, rather than removal of portions of the first electrode material 312 to form the plurality of expansion areas 314a, 314b, the plurality of expansion areas 314a, 314b, can be formed by selective deposition of the first electrode material 312 onto the anode current collector 320. In some embodiments, the selective deposition of the first electrode material 312 onto the anode current collector 320 can be accomplished by first disposing a mask material onto the anode current collector 320, then disposing the first electrode material 312 onto the anode current collector 320, and removing the mask to define the plurality of expansion areas 314a, 314b. In some embodiments, at least one of the first electrode material 112 and the second electrode material 114 can include a high-capacity material. In some embodiments, the high-capacity material can have any suitable form factor such as sheet, bulk material, micro-scale particles, nano-scale particles, or combinations thereof. In some embodiments, the high-capacity material can include any material capable of storing ions, including but not limited to silicon, bismuth, boron, gallium, indium, zinc, tin, antimony, aluminum, titanium oxide, molybdenum, germanium, manganese, niobium, vanadium, tantalum, iron, copper, gold, platinum, chromium, nickel, cobalt, zirconium, yttrium, molybdenum oxide, germanium oxide, silicon oxide, silicon carbide, any other high-capacity materials or alloys thereof, and any combination thereof.

In some embodiments, the anode 310 can include about 66 wt %-70 wt % Si, about 15 wt %-22 wt % Co, and about 4 wt %-12 wt % C. In some embodiments, the anode 310 can include about 70 wt % Si, about 15 wt %-20 wt % Ni and about 10 wt %-15 wt % C. In some embodiments, the anode 310 can include about 70 wt % Si, about 15 wt % Fe and about 15 wt % C. In some embodiments, the anode 310 can include about 70 wt % Si, about 20 wt % Ti, and about 10 wt % C. In some embodiments, the anode 310 can include about 70 wt % Si, about 15 wt % Mo and about 15 wt % C. In some embodiments, the anode 310 can include about 70 wt % Si, 15 wt % Co, 5 wt % Ni and about 10 wt % C. In some embodiments, the anode 310 can include about 70 wt % Si, about 10 wt % Co, about 10 wt % Ni and about 10 wt % C. In some embodiments, the anode 310 can include about 70 wt % Si, about 5 wt % Co, about 15 wt % Ni and about 10 wt % C. In some embodiments, the anode 310 can include about 70 wt % Si, about 5 wt % Fe, about 10 wt % Ni and about 15 wt % C. In some embodiments, the anode 310 can include about 70 wt % Si, 10 wt % Co and about 5 wt % Ni. In some embodiments, the anode 310 can include about 74 wt % Si, 2 wt % Sn and about 24 wt % Co. In some embodiments, the anode 310 can include about 73 wt % Si, about 2 wt % Sn and about 25 wt % Ni. In some embodiments, the anode 310 can include about 70 wt % Si, 10 wt % Fe, about 10 wt % Ti and about 10 wt % Co. In some embodiments, the anode 310 can include about 70 wt % Si, about 15 wt % Fe, about 5 wt % Ti and about 10 wt % C. In some embodiments, the anode 310 can include about 74.67 wt % Si, 16 wt % Fe, 5.33 wt % Ti and 4 wt % C. In some embodiments, the anode 310 can include about 55 wt % Si, 29.3 wt % Al and about 15.7 wt % Fe. In some embodiments, the anode 310 can include about 70 wt % Si, about 20 wt % C from a precursor and about 10 wt % graphite by weight. In some embodiments, the anode 310 can include about 55 wt % Si, about 29.3 wt % Al and about 15.7 wt % Fe. In some embodiments, the anode 310 can include about 60-62 wt % Si, about 16-20 wt % Al, about 12-14 wt % Fe, and about 8% Ti. In some embodiments, the anode 310 can include about 50 wt % Sn, about 27.3 wt %-35.1 wt % Co, about 5 wt %-15 wt % Ti, and about 7.7 wt %-9.9 wt % C. In some embodiments, the anode 310 can include about 50 wt % Sn, about 39-42.3 wt % Co, and about 7.7-11 wt % C. In some embodiments, the anode 310 can include about 35-70 mole % Si, about 1-45 mole % Al, about 5-25 mole % transition metal, about 1-15 mole % Sn, about 2-15 mole % yttrium, a lanthanide element, an actinide element or a combination thereof.

In some embodiments, the anode 310 can include a tin metal alloy such as, for example, a Sn—Co—C, a Sn—Fe—C, a Sn—Mg—C, or a La—Ni—Sn alloy. In some embodiments, the anode 310 can include an amorphous oxide such as, for example, SnO or SiO amorphous oxide. In some embodiments, the anode 310 can include a glassy anode such as, for example, a Sn—Si—Al—B—O, a Sn—Sb—S—O, a SnO₂—P₂O₅, or a SnO—B₂O₃—P₂O₅-Al₂O₃ anode. In some embodiments, the anode 310 can include a metal oxide such as, for example, a CoO, a SnO₂, or a V₂O₅. In some embodiments, the anode 310 can include a metal nitride such as, for example, Li₃N or Li_{2.6}Co_{0.4}N.

In some embodiments, the first electrode material 312 can include the high-capacity material and the second electrode material 314 can include a semi-solid electrode material. In some embodiments, the portions of the first electrode material 312, including the high-capacity material, removed to form the plurality of expansion areas 314a, 314b, can be substantially filled by the semi-solid electrode material when the second electrode material 314 is disposed onto the first electrode material 312. Without wishing to be bound by any particular theory, when the electrochemical cell is in operation, the high-capacity material may expand by up to about 400%, causing the first electrode material 312 to expand. In some embodiments, the second electrode material 314 can be configured to be deformed when the first electrode material 312 expands and/or contracts during operation of the electrochemical cell 300.

As shown, the anode 310 is depicted as a multi-layered electrode with expansion areas. In some embodiments, the cathode 330 can be a multi-layered electrode with expansion areas.

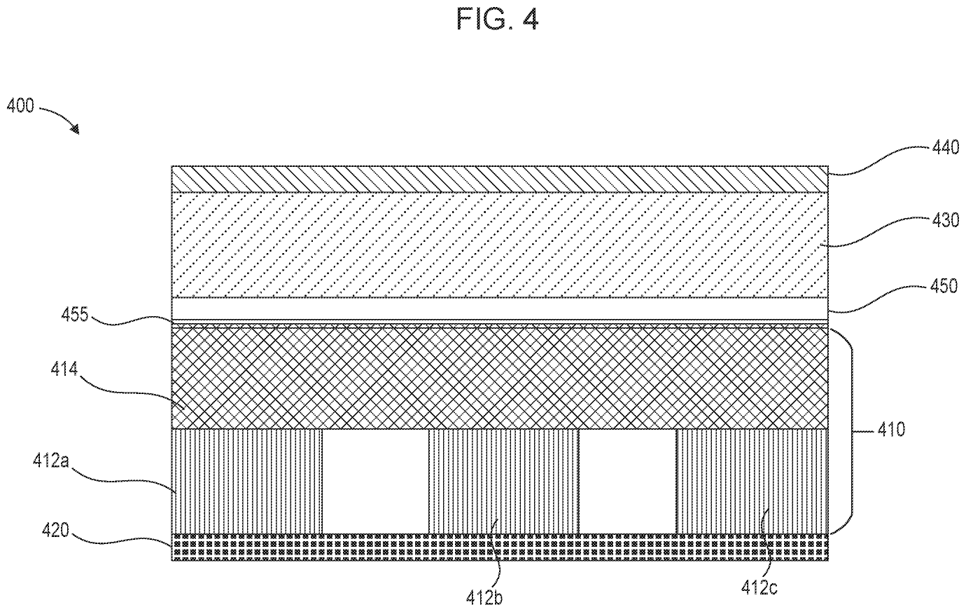

FIG. 4 is a side-view illustration of an electrochemical cell 400. The electrochemical cell 400 includes an anode 410 with a first electrode material 412 on an anode current collector 420 and a second electrode material 414 disposed on the first electrode material 412. The electrochemical cell 400 further includes a cathode 430 disposed on a cathode current collector 440 and a separator 450 disposed between the anode 410 and the cathode 430. A coating layer 455 is disposed on the separator 450.

In some embodiments, the anode 410, the first electrode material 412, the second electrode material 414, the anode current collector 420, the cathode 430, the cathode current collector 440, the separator 450, and the coating layer 455 can be the same or substantially similar to the anode 110, the first electrode material 112, the second electrode material 114, the anode current collector 120, the cathode 130, the cathode current collector 140, the separator 150, and the coating layer 155. Thus, certain aspects of the anode 410, the first electrode material 412, the second electrode material 414, the anode current collector 420, the cathode 430, the cathode current collector 440, the separator 450, and the coating layer 455 are not described in greater detail herein.

In some embodiments, the first electrode material 412 can include sputtered or electroplated silicon, while the second electrode material 414 can include a semi-solid electrode material. During operation, the first electrode material 412 (e.g., a sputtered silicon electrode) can develop cracks during cycling and split into multiple distinct portions (e.g., 412a, 412b, 412c). These cracks can potentially restrict electron movement in the horizontal direction (e.g., the x-direction or the y-direction). In other words, the electrons may only be able to efficiently move horizontally within the second electrode material 414. This reduction in electron mobility can cause lower energy density or power density performance in an electrochemical cell that includes the first electrode material 412.

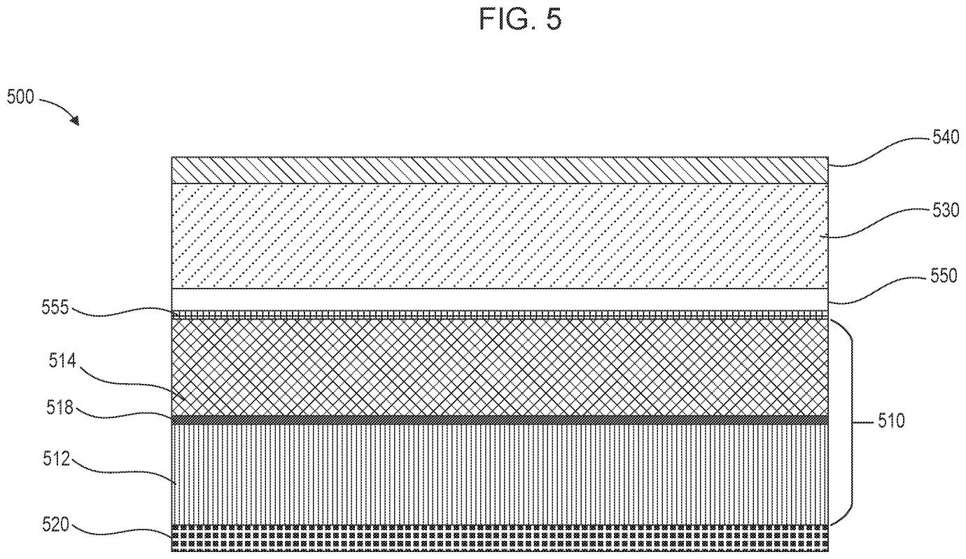

FIG. 5 is a side-view illustration of an electrochemical cell 500. The electrochemical cell 500 includes an anode 510 with a first electrode material 512 on an anode current collector 520, a second electrode material 514, and a third electrode material 518 disposed between the first electrode material 512 and the second electrode material 514. The electrochemical cell 500 further includes a cathode 530 disposed on a cathode current collector 540 and a separator 550 disposed between the anode 510 and the cathode 530. A coating layer 555 is disposed on the separator 550.

In some embodiments, the anode 510, the first electrode material 512, the second electrode material 514, the anode current collector 520, the cathode 530, the cathode current collector 540, the separator 550, and the coating layer 555 can be the same or substantially similar to the anode 110, the first electrode material 112, the second electrode material 114, the anode current collector 120, the cathode 130, the cathode current collector 140, the separator 150, and the coating layer 155. Thus, certain aspects of the anode 510, the first electrode material 512, the second electrode material 514, the anode current collector 520, the cathode 530, the cathode current collector 540, the separator 550, and the coating layer 555 are not described in greater detail herein. In some embodiments, the first electrode material 512 can include sputtered or electroplated silicon. In some embodiments, the third electrode material 518 can include graphite. Components of the first electrode material 512 (e.g., silicon) can continuously react with the electrolyte solution within the electrochemical cell, and controlling the SEI on the surface of the first electrode material 512 can be difficult. In some embodiments where the first electrode material 512 is sputtered or electroplated, the first electrode material 512 has a low porosity (i.e., less surface area for reaction with the electrolyte), however, a chemical reaction may still occur at the interface with the electrolyte. Therefore, coating the first electrode material 512 with a third electrode material 518 that includes, for example, graphite, can minimize these interfacial chemical reactions. In other words, while cracking of the first electrode material 512 can occur in some embodiments, cracking can be minimized or reduce by coating with the third electrode material 518. In addition, conductive materials (e.g., graphite) in the third electrode material 518 and the second electrode material 514 can migrate into the interstitial regions developed from the cracking of the first electrode material 512. The presence of the conductive material in these interstitial regions can facilitate vertical movement (i.e., in the z-direction) of electrons and remedy the performance reduction induced by the cracking of silicon.

Additional examples of electrodes and electrochemical cells including high-capacity materials, and methods of making the same can be found in U.S. Pat. No. 9,437,864, filed Sep. 6, 2016, entitled “Asymmetric Battery Having a Semi-Solid Cathode and High Energy Density Anode,” the entire disclosure of which is incorporated herein by reference.

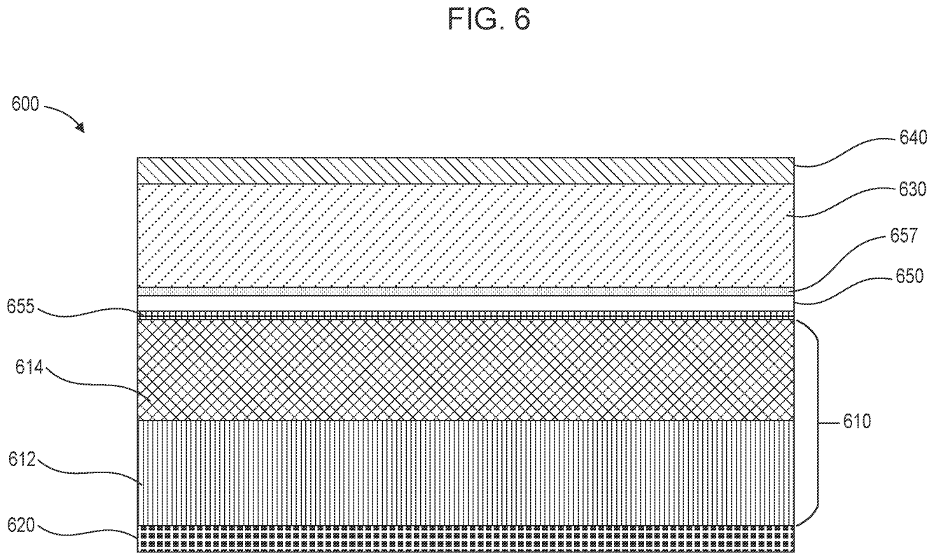

FIG. 6 is a side-view illustration of an electrochemical cell 600. The electrochemical cell 600 includes an anode 610 with a first electrode material 612 disposed on an anode current collector 620 and a second electrode material 614 disposed on the first electrode material 612. The electrochemical cell 600 further includes a cathode 630 disposed on a cathode current collector 640 and a separator 650 disposed between the anode 610 and the cathode 630. A first coating layer 655 is disposed on the anode side of the separator 650 while a second coating layer 657 is disposed on the cathode side of the separator 650.

In some embodiments, the anode 610, the first electrode material 612, the second electrode material 614, the anode current collector 620, the cathode 630, the cathode current collector 640, the separator 650, and the first coating layer 655 can be the same or substantially similar to the anode 110, the first electrode material 112, the second electrode material 114, the anode current collector 120, the cathode 130, the cathode current collector 140, the separator 150, and the coating layer 155. Thus, certain aspects of the anode 610, the first electrode material 612, the second electrode material 614, the anode current collector 620, the cathode 630, the cathode current collector 640, the separator 650, and the first coating layer 655 are not described in greater detail herein.

In some embodiments, the second coating layer 657 can be disposed on the cathode 630. In some embodiments, the second coating layer 657 can be disposed on the separator 650. In some embodiments, the second coating layer 657 can be composed of the same or a substantially similar material to the first coating layer 655. In some embodiments, the second coating layer 657 can be composed of a different material from the first coating layer. In some embodiments, the second coating layer 657 can include a layer of Al₂O₃ coated on the cathode 630. In some embodiments, the first coating layer 655 can include a layer of hard carbon coating on the anode side of the separator 650. In some embodiments, the addition of the second coating layer 657 can improve the balance the lithium diffusion on both the anode side and cathode side of the electrochemical cell 600, resulting in a fast charge capability and better NMC stability.

In some embodiments, the second coating layer 657 can have a thickness of at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 1.1 μm, at least about 1.2 μm, at least about 1.3 μm, at least about 1.4 μm, at least about 1.5 μm, at least about 1.6 μm, at least about 1.7 μm, at least about 1.8 μm, or at least about 1.9 μm. In some embodiments, the second coating layer 657 can have a thickness of no more than about 2 μm, no more than about 1.9 μm, no more than about 1.8 μm, no more than about 1.7 μm, no more than about 1.6 μm, no more than about 1.5 μm, no more than about 1.4 μm, no more than about 1.3 μm, no more than about 1.2 μm, no more than about 1.1 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, or no more than about 20 nm. Combinations of the above-referenced thicknesses of the second coating layer 657 are also possible (e.g., at least about 10 nm and no more than about 2 μm or at least about 200 nm and no more than about 1.5 μm), inclusive of all values and ranges therebetween. In some embodiments, the second coating layer 657 can have a thickness of about 10 nm, at about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 1.1 μm, about 1.2 μm, about 1.3 μm, about 1.4 μm, about 1.5 μm, about 1.6 μm, about 1.7 μm, about 1.8 μm, about 1.9 μm, or about 2 μm.

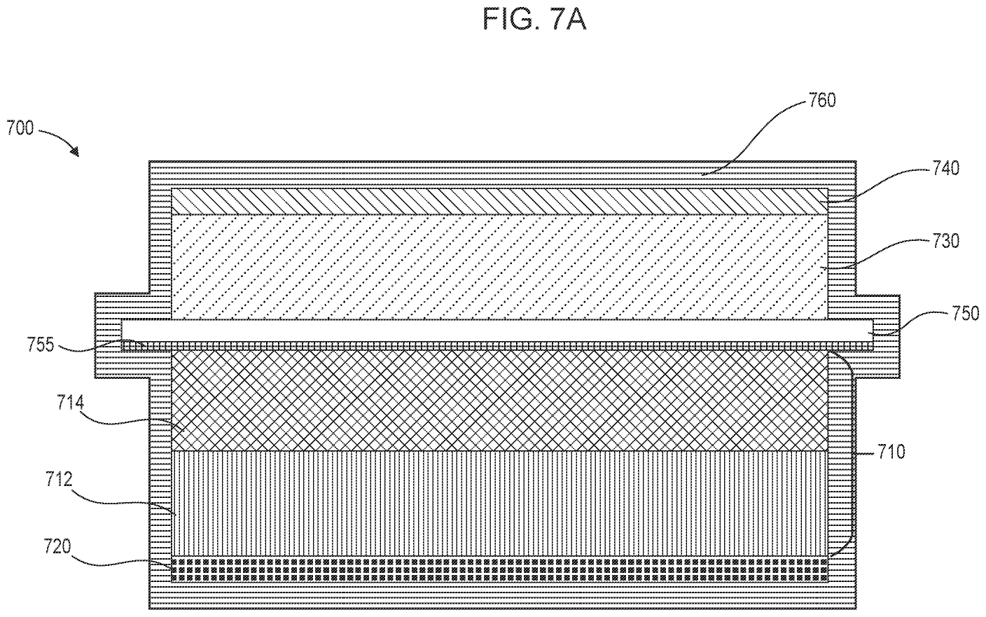

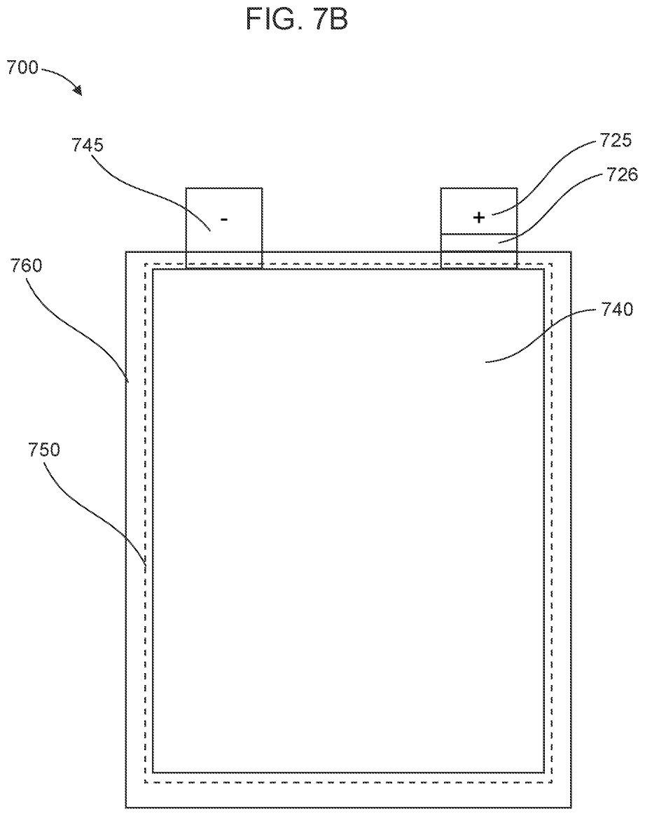

FIGS. 7A-7B are schematic illustrations of an electrochemical cell 700. FIG. 7A includes a cross-sectional view of the electrochemical cell 700, while FIG. 7B includes a top view of the electrochemical cell 700. The electrochemical cell 700 includes an anode 710 disposed on an anode current collector 720. The anode 710 includes a first electrode material 712 and a second electrode material 714. The electrochemical cell 700 further includes a cathode 730 disposed on a cathode current collector 740 and a separator 750 disposed between the anode 710 and the cathode 730. A coating layer 755 is disposed on the separator 750. The anode 710, the anode current collector 720, the cathode 730, the cathode current collector 740, the separator 750, and the coating layer 755 are disposed in a pouch 760. The anode current collector 720 includes an anode tab 725. The cathode current collector 740 includes a cathode tab 745.

In some embodiments, the anode 710, the first electrode material 712, the second electrode material 714, the anode current collector 720, the cathode 730, the cathode current collector 740, the separator 750, and the coating layer 755 can be the same or substantially similar to the anode 110, the first electrode material 112, the second electrode material 114, the anode current collector 120, the cathode 130, the cathode current collector 140, the separator 150, and the coating layer 155. Thus, certain aspects of the anode 710, the first electrode material 712, the second electrode material 714, the anode current collector 720, the cathode 730, the cathode current collector 740, the separator 750, and the coating layer 755 are not described in greater detail herein.

In some embodiments, the separator 750 can extend beyond the edges of the anode 710 and the cathode 730. In some embodiments, the coating layer 755 can be disposed on portions of the separator 750 that extend beyond the edges of the anode 710 and the cathode 730. In some embodiments, the portions of the separator 750 that extend beyond the separator 750 can be sealed to portions of the pouch 760. Sealing portions of the separator 750 to portions of the pouch 760 can help prevent the coating layer 755 from making contact with the cathode 730 or with cathodes from adjacent electrochemical cells. In some embodiments, if the coating layer 755 is disposed on the cathode side of the separator 750, sealing portions of the separator 750 to portions of the pouch 760 can help prevent the coating layer 755 from making contact with the anode 710 or with anodes from adjacent electrochemical cells. This isolation and contact prevention can aid in preventing short circuit events. The isolation and contact prevention can be particularly useful when an electrochemical cell is rolled up and disposed into a can, as contact between the coating layer 755 and a the walls of a can may result in a short circuit event. Further examples of electrochemical cells, in which edges of the separator are sealed to a pouch are further described in U.S. Pat. No. 9,178,200, (the ′200 Patent), entitled “Electrochemical Cells and Methods of Manufacturing the Same,” the disclosure of which is hereby incorporated by reference in its entirety. Further examples of single electrochemical cells disposed in pouches are further described in U.S. Pat. No. 10,181,587 (the ′587 Patent), entitled “Single Pouch Battery Cells and Methods of Manufacture,” the disclosure of which is hereby incorporated by reference in its entirety.

In order to further limit or prevent contact between the coating layer 755 and electroactive material from other electrochemical cells, an insulation 726 is shown between the anode tab 725 and the pouch 760. The insulation 726 further isolates the coating layer 755 from contact with electroactive species, further preventing short circuit events. In some embodiments, the insulation 726 can be disposed around a perimeter of the anode tab 725, creating a seal between the anode tab 725 and the pouch 760. In some embodiments, the insulation 726 can include an adhesive, a seal, a heat seal, or any other suitable means of insulation. In some embodiments, an insulation can exist between the cathode tab 745 and the pouch 760. In some embodiments, a first insulation can exist between the anode tab 725 and the pouch 760 and a second insulation can exist between the cathode tab 745 and the pouch 760.

As shown, the anode 710 includes a first electrode material 712 and a second electrode material 714. In some embodiments, the anode 710 can include a single electrode material. In other words, the anode 710 can be a single layer of electrode material. In some embodiments, the anode 710 can be a semi-solid electrode. In some embodiments, the anode 710 can be a conventional electrode. In some embodiments, the anode 710 can be a solid electrode. In some embodiments, the anode 710 can be a graphite electrode. In some embodiments, the anode 710 can be a semi-solid graphite electrode.

In some embodiments, the cathode 730 can include a single electrode material. In other words, the cathode 730 can be a single layer of electrode material. In some embodiments, the cathode 730 can be a semi-solid electrode. In some embodiments, the cathode 730 can be a conventional electrode. In some embodiments, the cathode 730 can be a solid electrode. In some embodiments, the cathode 710 can include NMC 811.

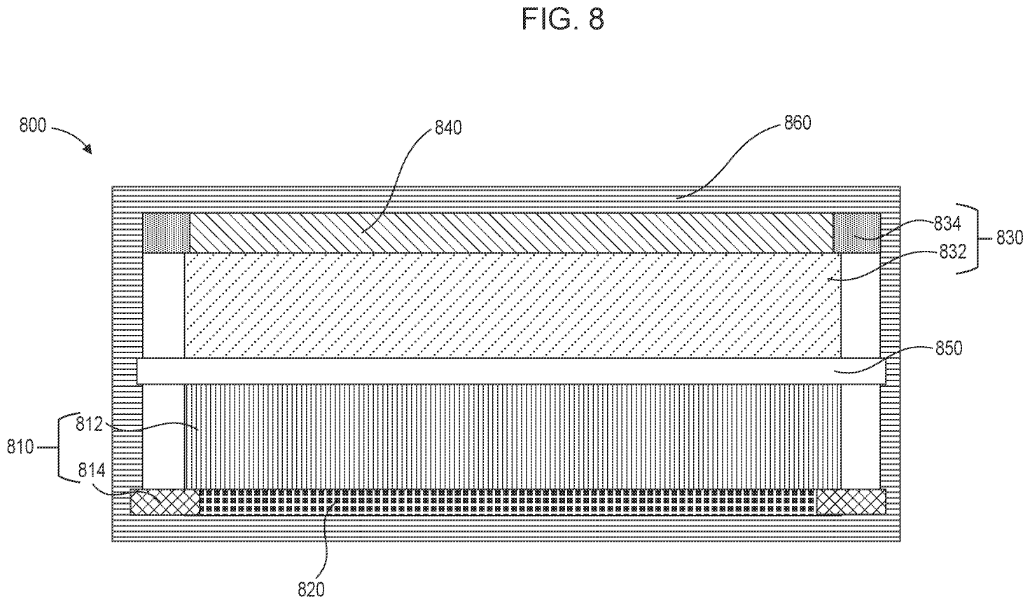

FIG. 8 is a side-view illustration of an electrochemical cell 800. The electrochemical cell 800 includes an anode 810 with a first electrode material 812 (also referred to as a first portion which is a first electroactive material) disposed on an anode current collector 820 and a second electrode material 814 (also referred to as a second portion which is a second electroactive material) disposed on a pouch 860 around an outside edge of the anode current collector 820. The first electrode material 812 and the second electrode material 814 are in ionic communication with one another (i.e., ions can flow to/from the first electrode material 812 to the second electrode material 814). The first electrode material 812 and the second electrode material 814 are also in electronic communication with one another (i.e., electrons can flow to/from the first electrode material 812 to the second electrode material 814). The electrochemical cell 800 further includes a cathode 830 disposed on a cathode current collector 840 and a separator 850 disposed between the anode 810 and the cathode 830. The separator 850 may have a first side adjacent to the anode 810 and a second side adjacent to the cathode 830. The cathode 830 includes a primary portion 832 and a migrated portion 834. In some embodiments, the anode current collector 820, the cathode current collector 840, the separator 850, and the pouch 860 can be the same or substantially similar to the anode current collector 720, the cathode current collector 740, the separator 750, and the pouch 760, as described above with reference to FIGS. 7A-7B. Thus, certain aspects of the anode current collector 820, the cathode current collector 840, the separator 850, and the pouch 860 are not described in greater detail herein.

As shown, a portion of the cathode 830 has migrated to a region surrounding the cathode current collector 840 to form the migrated portion 834 of the cathode 830. This can be due to the cathode 830 being formed from a semi-solid electrode material, such that the cathode 830 can flow and move more easily than a conventional solid electrode. When placed around the outside edge of the anode current collector 820, the second electrode material 814 of the anode 810 can capture electrons and/or ions transported from the migrated portion 834 of the cathode 830 across the separator 850. Once captured in the second electrode material 814, the electrons and/or ions can be transferred to the first electrode material 812. The placement of the second electrode material 814 can aid in preventing dendrite formation around the outside edge of the anode 810. In some embodiments, the pouch 860 can be heat-sealed to the separator 850. In some embodiments, portions of the pouch 860 can be heat-sealed to each other.

In some embodiments, the second electrode material 814 can have a thickness the same or substantially similar to a thickness of the anode current collector 820. In some embodiments, the second electrode material 814 can be composed of the same material as the first electrode material 812. In some embodiments, the second electrode material 814 can be composed of a different material from the first electrode material 812. In some embodiments, the second electrode material 814 can have be a higher voltage material than the first electrode material 812. Said another way, the second electrode material 814 can have a lower affinity for electron retention than the first electrode material 812, such that electrons and/or ions captured by the second electrode material 814 migrate to the first electrode material 812. In some embodiments, the first electrode material 812 can have any of the properties of the first electrode material 112, as described above with reference to FIG. 1. In some embodiments, the second electrode material 814 can include silicon, bismuth, boron, gallium, indium, zinc, tin, antimony, aluminum, titanium oxide, molybdenum, germanium, manganese, niobium, vanadium, tantalum, iron, copper, gold, platinum, chromium, nickel, cobalt, zirconium, yttrium, molybdenum oxide, germanium oxide, silicon oxide, silicon carbide, any other high capacity materials or alloys thereof, and any combination thereof. In some embodiments, the second electrode material 814 can include Li₂TiO₃, TiO₂, or any other suitable material for transferring electrons and/or ions to the first electrode material 812. As shown, the anode 810 includes the first electrode material 812 and the second electrode material 814, and the cathode 830 includes the primary portion 832 and the migrated portion 834. In some embodiments, the anode 810 can include a primary portion and a migrated portion, and the cathode 830 can include a first electrode material and a second electrode material.

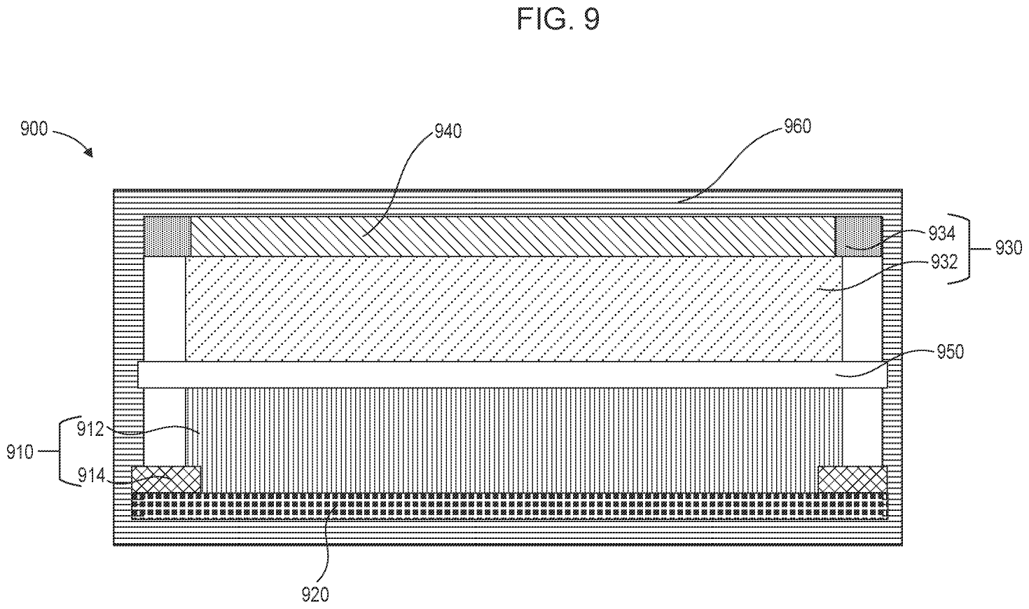

FIG. 9 is a side-view illustration of an electrochemical cell 900. The electrochemical cell 900 includes an anode 910 with a first electrode material 912 (also referred to as a first portion which is a first electroactive material) disposed on an anode current collector 920 and a second electrode material 914 (also referred to as a second portion which is a second electroactive material) disposed on the anode current collector 920 around an outside edge of the first electrode material 912. The first electrode material 912 and the second electrode material 914 are in ionic communication with one another (i.e., ions can flow to/from the first electrode material 912 to the second electrode material 914). The first electrode material 912 and the second electrode material 914 are also in electronic communication with one another (i.e., electrons can flow to/from the first electrode material 912 to the second electrode material 914). The electrochemical cell 900 further includes a cathode 930 disposed on a cathode current collector 940 and a separator 950 disposed between the anode 910 and the cathode 930. The separator 950 may have a first side adjacent to the anode 910 and a second side adjacent to the cathode 930. The cathode 930 includes a primary portion 932 and a migrated portion 934. The anode 910, the anode current collector 920, the cathode 930, the cathode current collector 940, and the separator 950 are disposed in a pouch 960. In some embodiments, the anode 910, the first electrode material 912, the second electrode material 914, the anode current collector 920, the cathode 930, the primary portion 932, the migrated portion 934, the cathode current collector 940, the separator 950, and the pouch 960 can be the same or substantially similar to the anode the anode 810, the first electrode material 812, the second electrode material 814, the anode current collector 820, the cathode 830, the primary portion 832, the migrated portion 834, the cathode current collector 840, the separator 850, and the pouch 860, as described above with reference to FIG. 8. Thus, certain aspects of the anode 910, the first electrode material 912, the second electrode material 914, the anode current collector 920, the cathode 930, the primary portion 932, the migrated portion 934, the cathode current collector 940, the separator 950, and the pouch 960 are not described in greater detail herein.

Placement of the second electrode material 914 on the anode current collector 920 around the outside of the first electrode material 912 can place the second electrode material 914 in closer proximity to the migrated portion 914 than if the second electrode material 914 is placed on the pouch 960. In some embodiments, the second electrode material 914 can be composed of a material with a lower affinity for electron retention than the first electrode material 912. As shown, the anode 910 includes the first electrode material 912 and the second electrode material 914. In some embodiments, the cathode 930 can include a first electrode material and a second electrode material. As shown, the cathode 930 includes the primary portion 932 and the migrated portion 934. In some embodiments, the anode 910 can include a primary portion and a migrated portion.

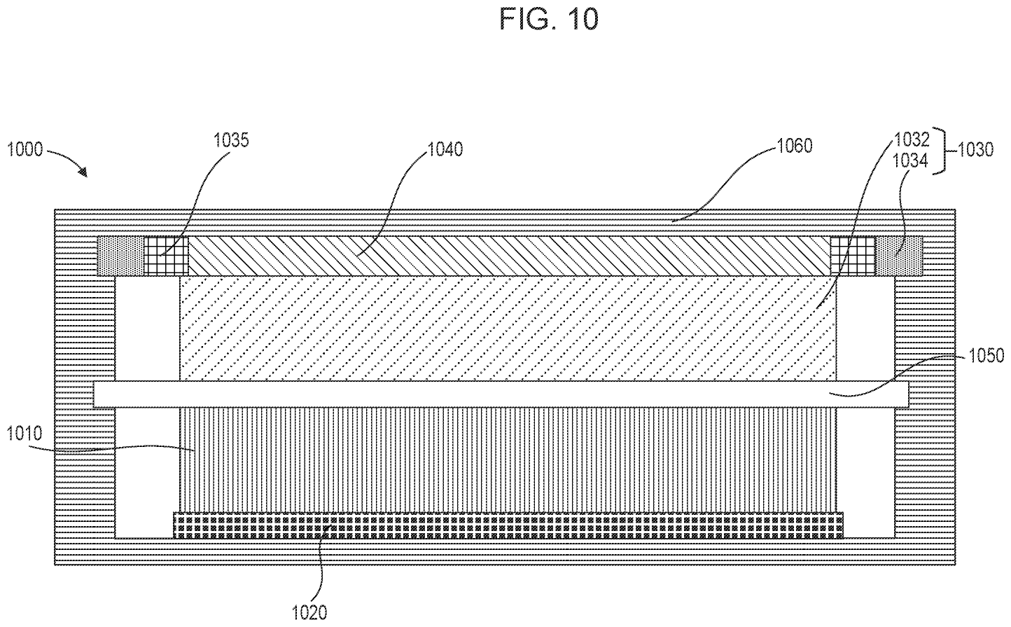

FIG. 10 is a side-view illustration of an electrochemical cell 1000. The electrochemical cell 1000 includes an anode 1010 disposed on an anode current collector 1020, a cathode 1030 disposed on a cathode current collector 1040, a separator 1050 disposed between the anode 1010 and the cathode 1050. The separator 1050 may have a first side adjacent to the anode 1010 and a second side adjacent to the cathode 1030. As shown, the anode 1010, the anode current collector 1020, the cathode 1030, the cathode current collector 1040, and the separator 1050 are disposed in a pouch 1060. As shown, the cathode 1030 includes a primary portion 1032 (also referred to herein as a first portion) and a secondary portion 1034 (also referred to herein as a migrated portion). A non-wettable coating 1035 is disposed on the pouch 1060 around an outside edge of the cathode current collector 1040. The non-wettable coating 1035 acts as an electronic barrier, electronically isolating the primary portion 1032 from the secondary portion 1034. In some embodiments, the anode 1010, the anode current collector 1020, the cathode 1030, the primary portion 1032, the secondary portion 1034, the cathode current collector 1040, the separator 1050, and the pouch 1060 can be the same or substantially similar to the anode 810, the anode current collector 820, the cathode 830, the primary portion 832, the secondary portion 834, the cathode current collector 840, the separator 850, and the pouch 860, as described above with reference to FIG. 8. Thus, certain aspects of the anode 1010, the anode current collector 1020, the cathode 1030, the primary portion 1032, the secondary portion 1034, the cathode current collector 1040, the separator 1050, and the pouch 1060 are not described in greater detail herein.

In some embodiments, the non-wettable coating 1035 can resist wetting from electrolyte. In some embodiments, the non-wettable coating 1035 can repel fragments of the primary portion 1032 that break off to form the secondary portion 1034 to a region disposed around an outside edge of the non-wettable coating 1035. In some embodiments, the non-wettable coating 1035 can facilitate movement of fragments of the primary portion 1032 via wicking action. This wicking action can form the secondary portion 1034 at the outer edge of the cathode current collector 1034. By repelling or pushing the fragments of the primary portion 1034 to form around the outside edge of the non-wettable coating 1035, the primary portion 1032 can form far enough away from the anode 1010 and the anode current collector 1020, such that any materials that pass through the separator 1050 from the secondary portion 1035 do not contact the anode 1010 or the anode current collector 1030. In some embodiments, placement of the non-wettable coating 1035 around the outside edge of the primary portion 1032 and/or around the outside edge of the cathode current collector 1040 can allow easy removal of the secondary portion 1034 and/or the non-wettable coating 1035 from the electrochemical cell 1000. In other words, the non-wettable coating 1035 can be removed from the outside edge of the primary portion 1032 and/or the cathode current collector 1040, removing the secondary portion 1034 along with the non-wettable coating 1035.

In some embodiments, the non-wettable coating 1035 can have a thickness that is the same or substantially similar to the thickness of the cathode current collector 1040. In some embodiments, the non-wettable coating 1035 can be composed of polytetrafluoroethylene (PTFE), polyimide, polyethylene terephthalate (PET), silicone, alumina, silica, perfluoro-alkyl-polyacrylate resins and polymers, polysilsesquioxane, poly(vinyl alcohol) based co-polymer with polydioctylfluorene (PFO), poly(vinyl alcohol) based co-polymer combined with silica/alumina as an oil repellent coating, or any combination thereof. As shown, the non-wettable coating 1035 is disposed around the outside edge of the cathode current collector 1040. In some embodiments, the non-wettable coating 1035 can be disposed around the outside edge of the anode current collector 1020. In some embodiments, the non-wettable coating 1035 can be disposed on the cathode current collector 1040 around the outside edge of the cathode 1030. In some embodiments, the non-wettable coating 1035 can be disposed on the anode current collector 1020 around the outside edge of the anode 1010.

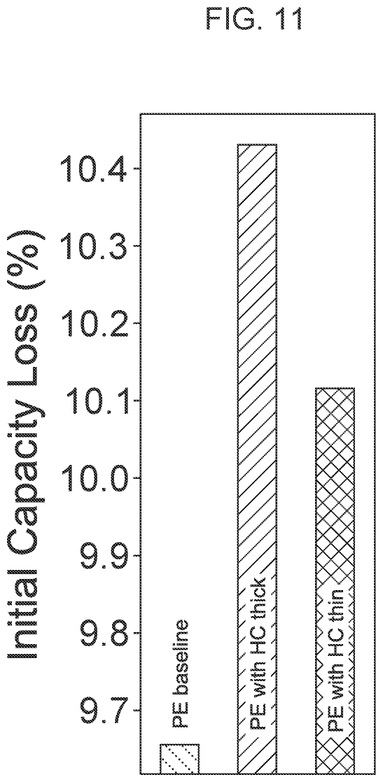

FIG. 11 is a graphical representation of initial capacity loss in different electrochemical cell configurations. The cells evaluated in this case include a cathode with NMC 811 and a semi-solid graphite anode. As compared to baseline cases with conventional separators without coating, cells that include polyethylene separators spray coated with thick coating (i.e., about 10 μm) and thin coating (i.e., less than 5 μm) on the anode side have an increase in initial capacity loss of about 0.5% to about 0.7%, depending on thickness. This is due to a larger volume and surface area of territory, in which a solid-electrolyte interface (SEI) layer is forming. Pre-lithiation of the anode can potentially reduce or mitigate this initial capacity loss.

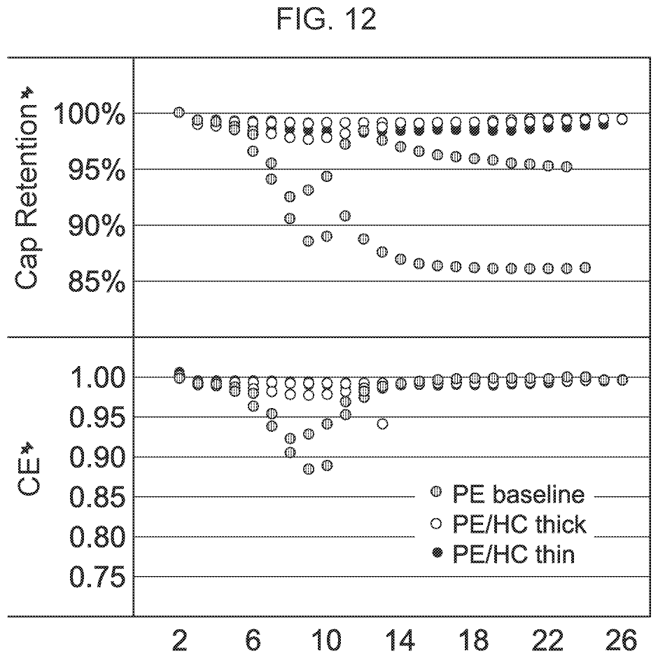

FIG. 12 is a graphical representation of capacity retention vs. number of cycles in different electrochemical cell configurations. Similar to FIG. 11, FIG. 12 includes an electrochemical cell with an NMC 811 cathode, a semi-solid graphite anode, and a conventional polyethylene separator compared to electrochemical cells with an NMC 811 cathode, a semi-solid graphite anode and polyethylene separators coated with a thin coating (i.e., less than 5 μm) and a thick coating (i.e., about 10 μm) of hard carbon on the anode side. The top plot shows the baseline case having an initial decline in capacity during the first few cycles and then a recovery, before fast fading of capacity. The polyethylene separators with hard carbon coating have an initial slight capacity loss, and then recover, maintaining about 98%-99% capacity through 26 cycles. The bottom plot shows an initial decline in coulombic efficiency of the baseline case and recovery around the 12^{th} cycle. The bottom plot also shows the cells with hard carbon coating on the separator maintaining high coulombic efficiency throughout.

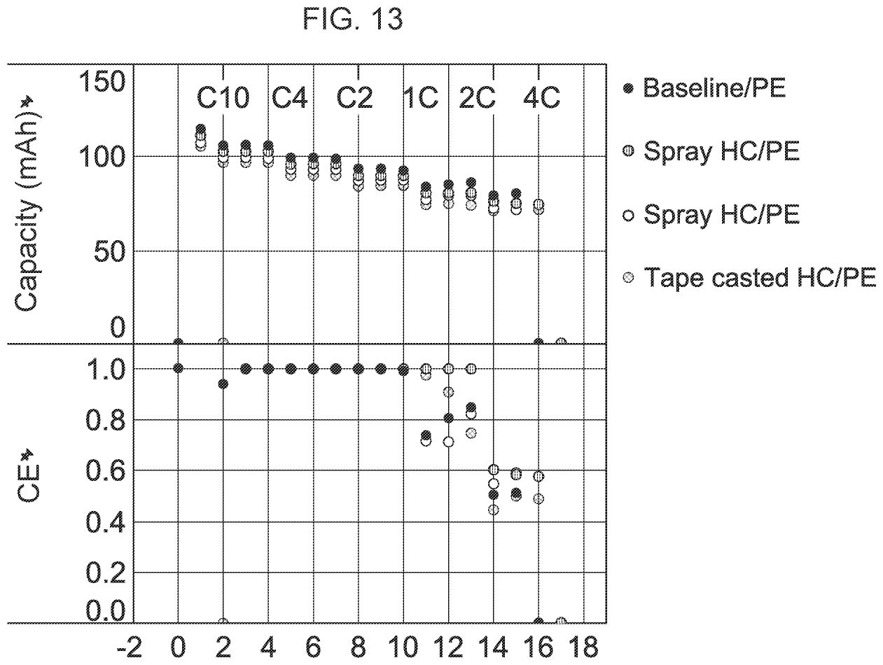

FIG. 13 is a graphical representation of capacity retention vs. number of cycles and C-rate in different electrochemical cell configurations. Each cell includes an NMC811 cathode, a Li metal anode, and a polyethylene separator. The baseline case includes no coating on the separator, while other cases include hard carbon either sprayed or tape casted onto the separator. During the earlier cycles, the C-rate is low, and the C-rate increases throughout the 18 cycles. The cells with separators sprayed with hard carbon have about 99% coulombic efficiency at 1 C while the baseline case has decreased to a coulombic efficiency of about 75%. The sprayed hard carbon cases survived after three cycles at 4 C while the baseline case failed at the first cycle at 4 C.

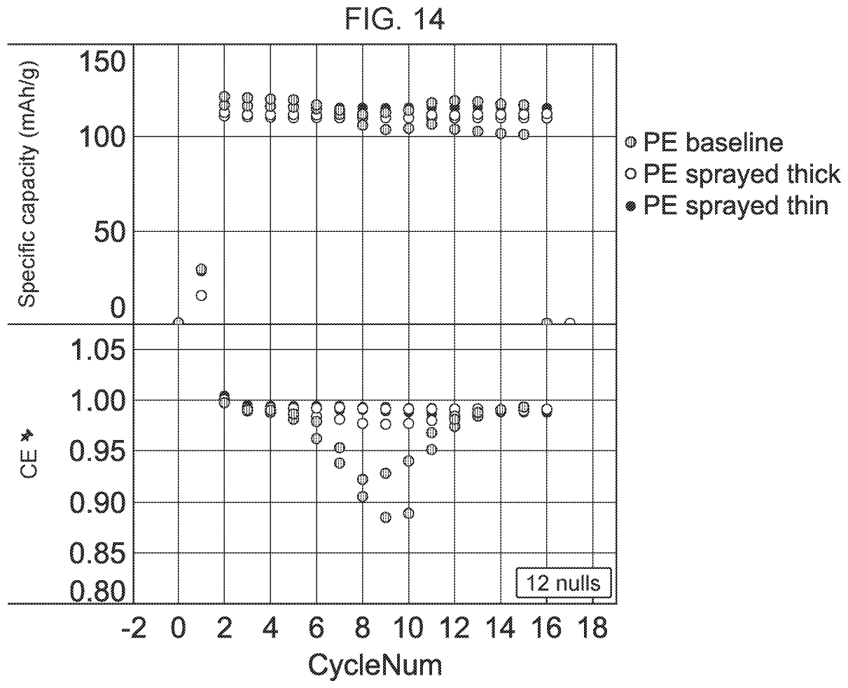

FIG. 14 is a graphical representation of capacity retention vs. number of cycles and C-rate in different electrochemical cell configurations. Each cell includes an NMC811 cathode, graphite anode, and a polyethylene separator. The baseline cell includes no coating on the separator, while other cells include separators sprayed with a thin coating (i.e., <5 μm) of hard carbon and a thick coating (i.e., about 10 μm) of hard carbon on the anode side. At a 1.4 C charge rate, the coulombic efficiency of the baseline case drops to about 90% and then recovers, while the hard carbon coated cases are stable at around 99.5%-99.9%. The baseline case capacity fades faster than the capacities of the cells with hard carbon coating.

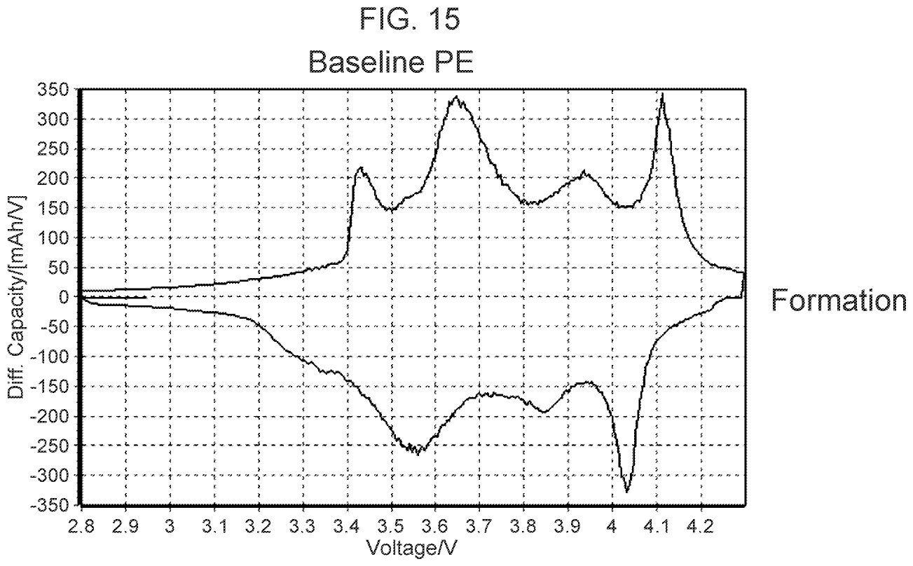

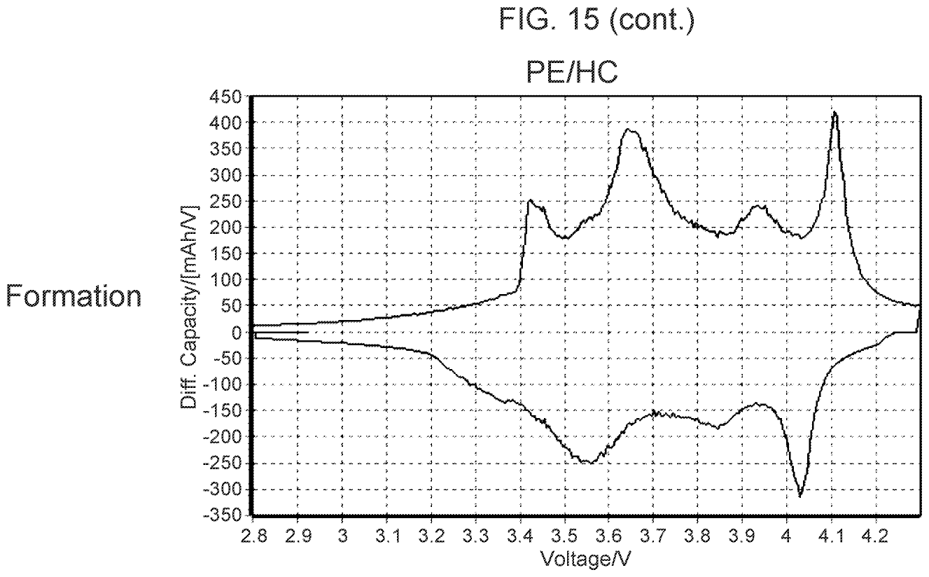

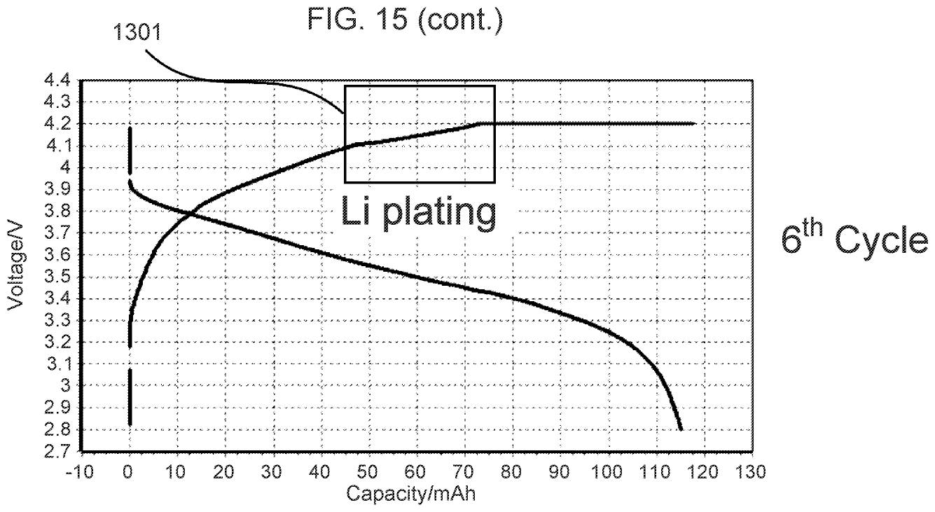

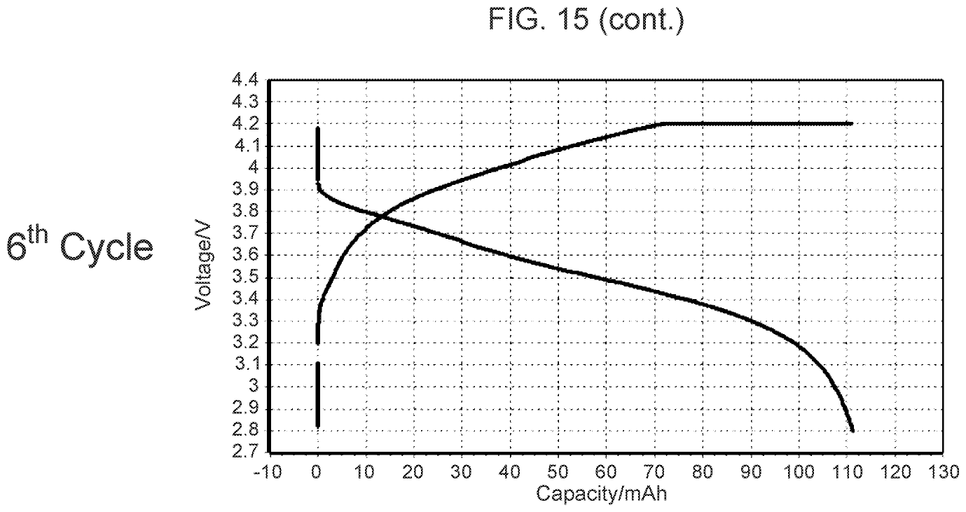

FIG. 15 is a graphical representation of dQ/dV and voltage profile comparisons between different electrochemical cell configurations. The plot on the top left shows differential capacity vs. voltage for a baseline case with an uncoated polyethylene separator. The bottom left plot shows a voltage vs. capacity plot for charging and discharging of the baseline case. The top right plot shows differential capacity vs. voltage for a cell with a polyethylene separator coated with hard carbon. The bottom right plot shows a voltage vs. capacity plot for charging and discharging of a cell with a polyethylene separator coated with hard carbon. Section 1501 on the bottom left plot shows a lag in voltage increase during charging. This is due to lithium plating and irreversible capacity loss. The plot on the bottom right does not have this anomaly and is charging more efficiently.

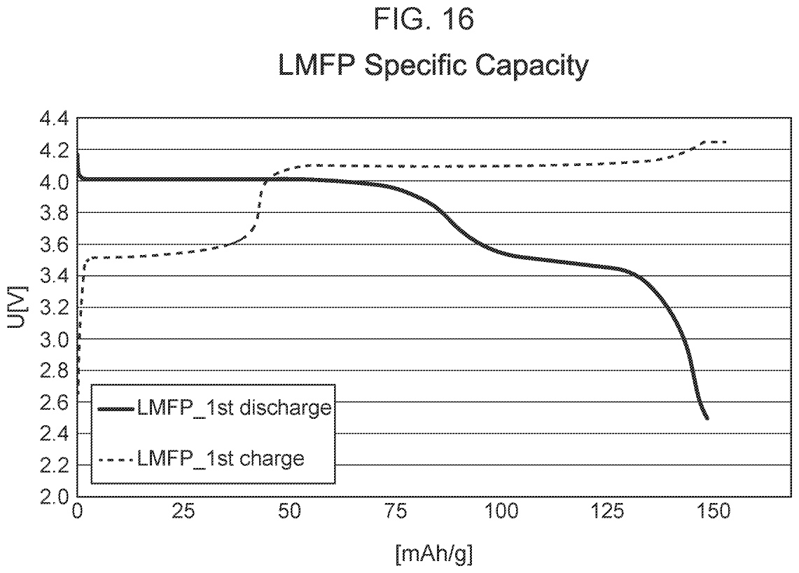

FIG. 16 is a graphical representation of half cell voltage curves for lithium manganese iron phosphate (LMFP). LMFP has a flat voltage profile at about 4.15V. On the surface of an NMC electrode, LMFP coating can prevent overpotential losses in NMC material.

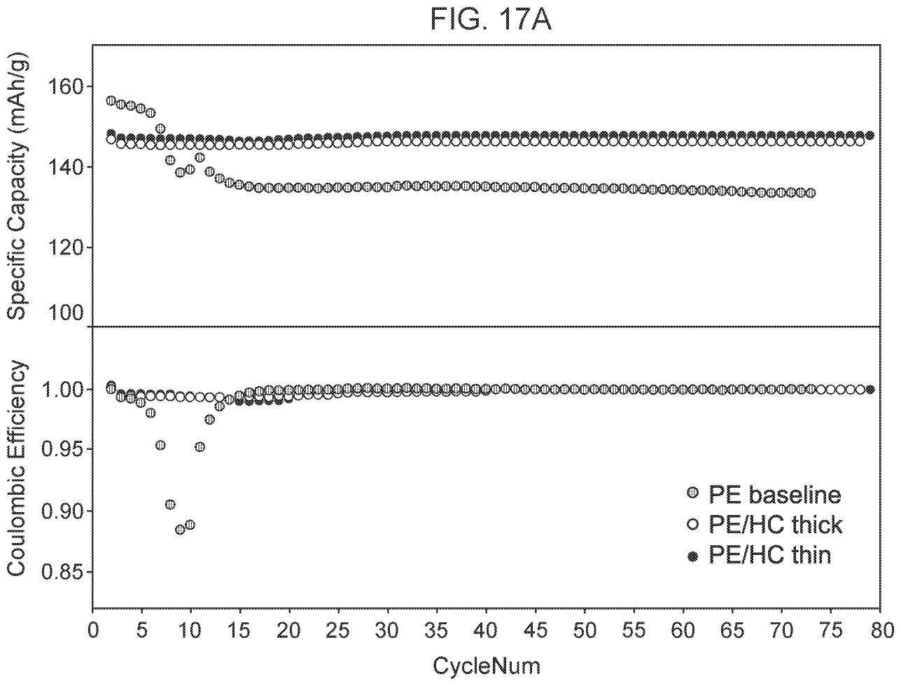

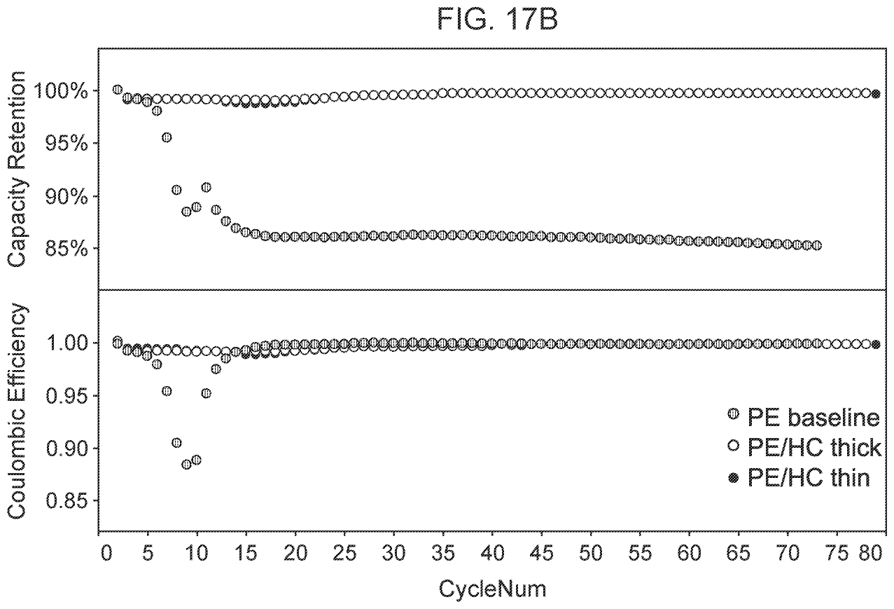

FIGS. 17A-17B are graphical representations of capacity retention vs. number of cycles in different electrochemical cells. The top plot in FIG. 17A shows absolute capacity per cycle, while the top plot in plot 17B shows capacity retention percentage, relative to the first cycle. FIGS. 17A-17B include an electrochemical cell with an NMC 811 cathode, a semi-solid graphite anode, and a conventional polyethylene separator compared to electrochemical cells with an NMC 811 cathode, a semi-solid graphite anode and polyethylene separators coated with a thin coating (i.e., less than 5 μm) and a thick coating (i.e., about 10 μm) of hard carbon on the anode side. The baseline case has an initial decline in capacity during the first few cycles and then a slight recovery, before fading to about 85% of its initial capacity. The polyethylene separators with hard carbon coating maintain about 98%-99% of their initial capacity through 80 cycles. The bottom plot in both FIG. 17A and FIG. 17B shows an initial decline in coulombic efficiency of the baseline case and recovery around the 12^{th} cycle. The bottom plot also shows the cells with hard carbon coating on the separator maintaining high coulombic efficiency throughout.

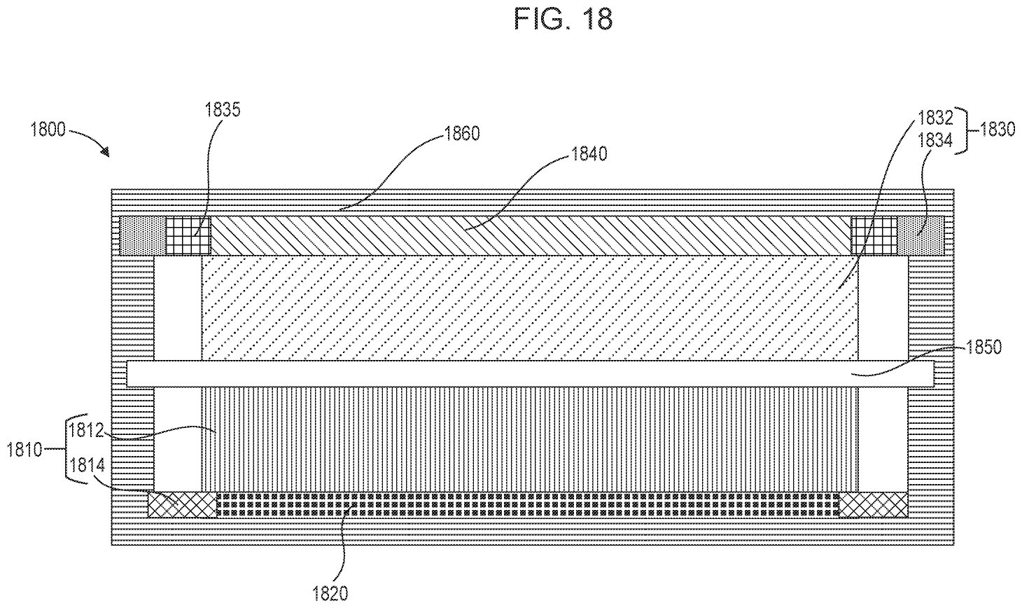

FIG. 18 is a is a side-view illustration of an electrochemical cell 1800. The electrochemical cell 1800 includes an anode 1810 with a first electrode material 1812 (also referred to as a first portion which is a first electroactive material) disposed on an anode current collector 1820 and a second electrode material 1814 (also referred to as a second portion which is a second electroactive material) disposed on a pouch 1860 around an outside edge of the anode current collector 820. The first electrode material 1812 and the second electrode material 1814 are in ionic communication with one another (i.e., ions can flow to/from the first electrode material 1812 to the second electrode material 1814). The first electrode material 1812 and the second electrode material 1814 are also in electronic communication with one another (i.e., electrons can flow to/from the first electrode material 1812 to the second electrode material 1814). The electrochemical cell 1800 further includes a cathode 1830 disposed on a cathode current collector 1840 and a separator 1850 disposed between the anode 1810 and the cathode 1830. The separator 1850 may have a first side adjacent to the anode 1810 and a second side adjacent to the cathode 1830. As shown, the cathode 1830 includes a primary portion 1832 (also referred to as a first portion) and a secondary portion 1834 (also referred to as a migrated portion). A non-wettable coating 1835 is disposed on the pouch 1860 around an outside edge of the cathode current collector 1840. The non-wettable coating 1835 acts as an electronic barrier, electronically isolating the primary portion 1832 from the secondary portion 1834. In some embodiments, the anode 1810, the first electrode material 1812, the second electrode material 1814, the anode current collector 1820, the cathode 1830, the primary portion 1832, the secondary portion 1834, the cathode current collector 1840, the separator 1850, and the pouch 1860 can be the same or substantially similar to the anode 810, the first electrode material 812, the second electrode material 1814, the anode current collector 820, the cathode 830, the primary portion 832, the secondary portion 834, the cathode current collector 840, the separator 850, and the pouch 860, as described above with reference to FIG. 8. Thus, certain aspects of the anode 1810, the first electrode material 812, the second electrode material 814, the anode current collector 1820, the cathode 1830, the primary portion 1832, the secondary portion 1834, the cathode current collector 1840, the separator 1850, and the pouch 1860 are not described in greater detail herein. FIG. 18 demonstrates an electrochemical cell wherein the first electrode material 1812 and second electrode material 1814 are on the anode side and the non-wettable coating 1835 is on the cathode side, but in some embodiments, the cathode 1830 can include a first electrode material and a second electrode material and a non-wettable coating 1835 can be disposed on the pouch 1860 around an outside edge of the anode current collector 1820.

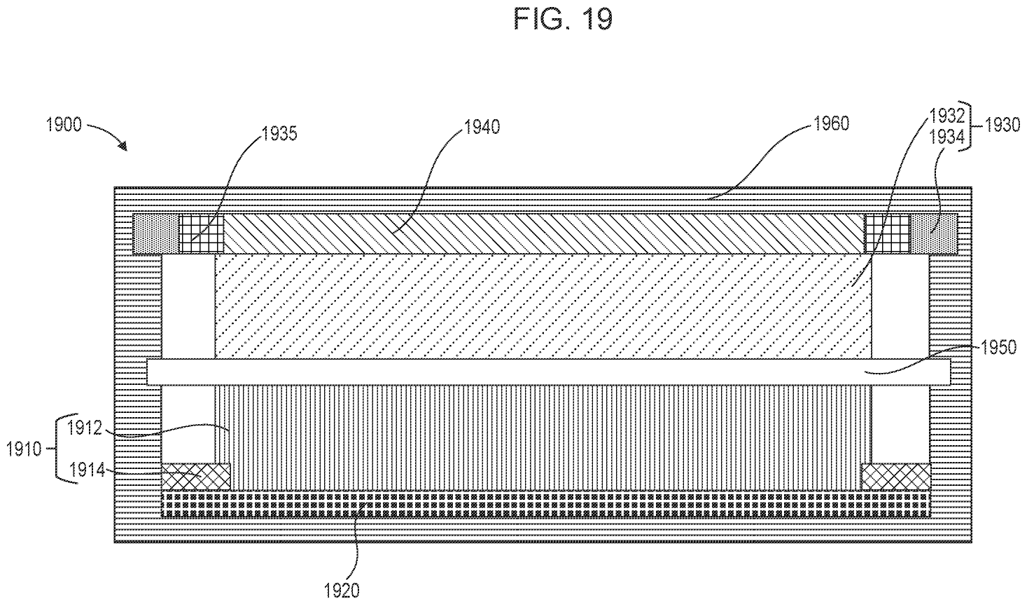

FIG. 19 is a is a side-view illustration of an electrochemical cell 1900. The electrochemical cell 1900 includes an anode 1910 with a first electrode material 1912 (also referred to as a first portion which is a first electroactive material) disposed on an anode current collector 1920 and a second electrode material 1914 (also referred to as a second portion which is a second electroactive material) disposed on the anode current collector 1920 around an outside edge of the first electrode material 1912. The first electrode material 1912 and the second electrode material 1914 are in ionic communication with one another (i.e., ions can flow to/from the first electrode material 1912 to the second electrode material 1914). The first electrode material 1812 and the second electrode material 1814 are also in electronic communication with one another (i.e., electrons can flow to/from the first electrode material 1812 to the second electrode material 1814). The electrochemical cell 1900 further includes a cathode 1930 disposed on a cathode current collector 1940 and a separator 1950 disposed between the anode 1910 and the cathode 1930. The separator 1950 may have a first side adjacent to the anode 1910 and a second side adjacent to the cathode 1930. As shown, the cathode 1930 includes a primary portion 1932 (also referred to as a first portion) and a secondary portion 1934 (also referred to as a migrated portion). A non-wettable coating 1935 is disposed on the pouch 1960 around an outside edge of the cathode current collector 1940. The non-wettable coating 1935 acts as an electronic barrier, electronically isolating the primary portion 1932 from the secondary portion 1934. In some embodiments, the anode 1910, the first electrode material 1912, the second electrode material 1914, the anode current collector 1920, the cathode 1930, the primary portion 1932, the secondary portion 1934, the cathode current collector 1940, the separator 1950, and the pouch 1960 can be the same or substantially similar to the anode 910, the first electrode material 912, the second electrode material 914, the anode current collector 920, the cathode 830, the primary portion 932, the secondary portion 934, the cathode current collector 940, the separator 950, and the pouch 960, as described above with reference to FIG. 9. Thus, certain aspects of the anode 1910, the first electrode material 1912, the second electrode material 1914, the anode current collector 1920, the cathode 1930, the primary portion 1932, the secondary portion 1934, the cathode current collector 1940, the separator 1950, and the pouch 1960 are not described in greater detail herein. FIG. 19 demonstrates an electrochemical cell wherein the first electrode material 1912 and second electrode material 1914 are on the anode side and the non-wettable coating 1935 is on the cathode side, but in some embodiments, the cathode 1930 can include a first electrode material and a second electrode material and a non-wettable coating 1935 can be disposed on the pouch 1960 around an outside edge of the anode current collector 1920.

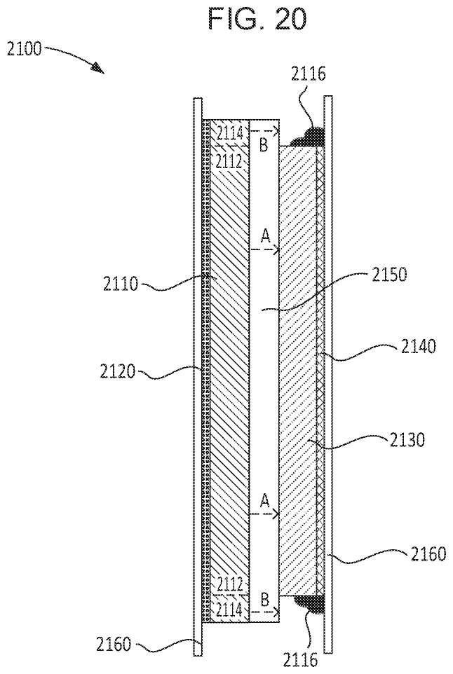

FIG. 20 shows a conventional electrochemical cell undergoing a short circuit event. Short circuit events in electrochemical cells can often be caused by the deposition of anode material near the cathode or by deposition of cathode material near the anode (this is also known as dendrite formation). Once enough anode material has built up near the cathode, or vice versa, physical contact between anode material and cathode material can lead to a short circuit event. FIG. 20 shows an electrochemical cell 2000 with an anode 2010 disposed on an anode current collector 2020, a cathode 2030 disposed on a cathode current collector 2040 and a separator 2050 disposed between the anode 2010 and the cathode 2030. The anode current collector 2020 and the cathode current collector 2040 are both disposed on a pouch material 2060. As shown, the cathode 2030 has a first section 2032 and a second section 2034. The first section 2032 is in-line with the anode 2010 while the second section 2034 is not in-line with the anode 2010. In other words, ions migrate from the first section 2032 to the anode 2010 via lines A. Ions migrate from the second section 2034 via lines B, but since the second section 2034 is not in-line with the anode 2010, cathode material deposits 2036 form near the anode 2010, either on the surface of the anode current collector 2020 or on the surface of the pouch material 2060. When the cathode material deposits 2036 are large enough to physically contact the anode 2010, a partial or full short circuit event can result. Additionally, the cathode material deposits 2036 represent material that has separated from the cathode 2030, such that it can no longer be used in the cycling of the electrochemical cell 2000. This can negatively affect the cycling performance of the electrochemical cell 2000.

The presence of a second anode electrode material 814, 914, 1814, 1914, as described above with reference to FIGS. 8, 9, 18 and 19, provides a site in the electrochemical cell at which cathode deposits such as those described in FIG. 20—and particularly cathode deposits originating from the migrated portion of the cathode 834, 934, 1834, 1934 in FIGS. 8, 9, 18 and 19—will preferentially form or be prevented from forming. The second electrode material 814, 914, 1814, 1914 has a higher potential compared to the first electrode material 812, 912, 1812, 1912 at the same stage of lithiation, which blocks dendrite growth on the edges of the first electrode material 812, 912, 1812, 1912. The second electrode material 814, 914, 1814, 1914 has a higher lithium storage potential (i.e., lithiation potential) than the first electrode material 812, 912, 1812, 1912 (e.g., graphite). In some cases, the cathode deposits forming on the second electrode material 814, 914, 1814, 1914 are prevented from physically contacting the first electrode material 812, 912, 1812, 1912 and/or anode current collector 820, 920, 1820, 1920 and as such, a partial or full short circuit event is prevented. While embodiments are described in respect of the first and second electrode materials forming part of the anode, and cathode deposits forming, the above explanation also applies when the first and second electrode materials form part of the cathode, and anode deposits form.

As described with reference to FIGS. 10, 18 and 19 above, by repelling or pushing the fragments of the primary portion 1032, 1832, 1932 to form a migrated portion 1034, 1834, 1934 around the outside edge of the non-wettable coating 1035, 1835, 1935, the migrated portion 1034, 1834, 1934 can form far enough away from the anode 1010, 1810, 1910 and the anode current collector 1020, 1820, 1920 such that any cathode materials that pass through the separator 1050, 1850, 1950 from the migrated portion 1034, 1834, 1934 do not contact the anode 1010, 1810, 1910 or the anode current collector 1030, 1830, 1930. The non-wettable coating 1035, 1835, 1935, as described above, can also provide a physical barrier which prevents anode deposits from forming on the primary portion of the cathode 1032, 1832, 1932 or on the cathode current collector 1040, 1840, 1940. The non-wettable coating is impassable for portions of the anode and thus any anode deposits that form on the migrated portion 1034, 1834, 1934 are prevented from physically contacting the primary portion of the cathode 1032, 1832, 1932 or the cathode current collector 1040, 1840, 1940 and as such, a partial or full short circuit even is prevented. Whilst embodiments are described in respect of the first and second cathode portion and anode deposits forming, the above explanation also applies when the non-wettable coating separates a primary portion of the anode or the anode current collector from cathode deposits.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1-41. (canceled)

42. An electrochemical cell, comprising:
an anode disposed on an anode current collector;
a cathode disposed on a cathode current collector; and
a separator disposed between the anode and the cathode, the separator having a first side adjacent to the anode and a second side adjacent to the cathode,
wherein a non-wettable coating is disposed on the anode current collector around an outside edge of the anode and/or a non-wettable coating is disposed on the cathode current collector around an outside edge of the cathode.

43. The electrochemical cell of claim 42, wherein the non-wettable coating is disposed on the anode current collector around an outside edge of the anode.

44. The electrochemical cell of claim 42, wherein the non-wettable coating is disposed on the cathode current collector around an outside edge of the cathode.

45. An electrochemical cell, comprising:
an anode disposed on an anode current collector;
a cathode disposed on a cathode current collector; and
a separator disposed between the anode and the cathode, the separator having a first side adjacent to the anode and a second side adjacent to the cathode,
wherein a non-wettable coating is disposed around an outside edge of the anode current collector and/or a non-wettable coating is disposed around an outside edge of the cathode current collector.

46. The electrochemical cell of claim 45, wherein the non-wettable coating is disposed around an outside edge of the anode current collector.

47. The electrochemical cell of claim 45, wherein the non-wettable coating is disposed around an outside edge of the cathode current collector.

48. The electrochemical cell of claim 45, wherein the non-wettable coating is disposed on a pouch material.

49. The electrochemical cell of claim 45 wherein the non-wettable coating acts as an electronic barrier.

50. The electrochemical cell of a claim 42, wherein the non-wettable coating resists wetting from electrolyte.

51. The electrochemical cell of claim 42, wherein the non-wettable coating is disposed on the anode current collector or around the outside edge of the anode current collector and, during use, the non-wettable coating;
repels fragments of the anode to form a migrated portion of the anode in an outside region surrounding the non-wettable coating, or
facilitates movement of fragments of anode to form a migrated portion of the anode via a wicking action.

52. The electrochemical cell of claim 42, wherein the non-wettable coating is disposed on the cathode current collector or around the outside edge of the cathode current collector and, during use, the non-wettable coating:
repels fragments of the cathode to form a migrated portion of the cathode in an outside region surrounding the non-wettable coating, or
facilitates movement of fragments of cathode to form a migrated portion of the cathode via a wicking action.

53. The electrochemical cell of claim 42, wherein a thickness of the non-wettable coating is the same as a thickness of the cathode current collector or anode current collector on or around which it is disposed.

54. The electrochemical cell of claim 42, wherein the non-wettable coating comprises polytetrafluoroethylene (PTFE), polyimide, polyethylene terephthalate (PET), silicone, alumina, silica, perfluoro-alkyl-polyacrylate resins and polymers, polysilsesquioxane, poly(vinyl alcohol) based co-polymer with polydioctylfluorene (PFO), poly(vinyl alcohol) based co-polymer combined with silica/alumina as an oil repellent coating, or any combination thereof.

55. The electrochemical cell of claim 45, wherein at least the first portion of the anode and/or cathode is a semi-solid anode material and/or a semi solid cathode material.

56. The electrochemical cell of claim 45, wherein at least the first portion of the anode is a graphite electrode.

57. The electrochemical cell of claim 45, wherein at least the first portion of the cathode includes NMC 811.

58. The electrochemical cell of claim 45, wherein the anode, anode current collector, cathode, cathode current collector, separator, first portion and second portion are disposed in a pouch.

59. The electrochemical cell of claim 45, any wherein portions of the separator extend beyond the edges of the anode and cathode.

60. The electrochemical cell of claim 59, wherein the anode, anode current collector, cathode, cathode current collector, separator, first portion and second portion are disposed in a pouch and the portions of the separator that extend beyond the edges of the anode and cathode are sealed to portions of the pouch.

61. A method of preparing an electrochemical cell, the method comprising:
a) disposing a first portion of an anode on an anode current collector;
b) disposing a first portion of a cathode on a cathode current collector;
c) disposing a separator between the first anode portion and the first cathode portion;
d) disposing a second portion of the anode on the anode current collector around an outside edge of the anode current collector, and/or disposing a second portion of the cathode on the cathode current collector around an outside edge of the cathode current collector;
e) disposing the anode current collector, anode, cathode current collector, cathode and separator in a pouch; and
f) sealing the pouch to form the electrochemical cell.

62-64. (canceled)

65. The method of claim 61, wherein the first portion is a first electroactive material and the second portion is a second electroactive material

66. The method of claim 61, wherein the second portion of the anode is disposed on the anode current collector around an outside edge of the anode current collector, on the pouch material around the outside edge of the anode current collector, on the anode current collector around at least part of an outside edge of the first portion of the anode, or around an outside edge of the anode current collector and around at least part of an outside edge of the first portion of the anode.

67. The method of claim 61, wherein the second portion of the cathode is disposed on the cathode current collector around an outside edge of the cathode current collector, on the pouch material around the outside edge of the cathode current collector, on the cathode current collector around at least part of an outside edge of the first portion of the cathode, or around an outside edge of the cathode current collector and around at least part of an outside edge of the first portion of the cathode.

68. The method of claim 61, wherein the second portion of the anode is disposed on the anode current collector around an outside edge of the anode current collector, on the pouch material around the outside edge of the anode current collector, on the anode current collector around at least part of an outside edge of the first portion of the anode, or around an outside edge of the anode current collector and around at least part of an outside edge of the first portion of the anode; and the second portion of the cathode is disposed on the cathode current collector around an outside edge of the cathode current collector, on the pouch material around the outside edge of the cathode current collector, on the cathode current collector around at least part of an outside edge of the first portion of the cathode, or around an outside edge of the cathode current collector and around at least part of an outside edge of the first portion of the cathode.

69. The method of claim 66 further comprising: disposing a non-wettable coating around an outside edge of the cathode current collector.

70. The method of claim 67 further comprising: disposing a non-wettable coating around an outside edge of the anode current collector.

71. The method of claim 66 further comprising: disposing a non-wettable coating on the cathode current collector around an outside edge of the first portion of the cathode.

72. The method of claim 67 further comprising: disposing a non-wettable coating on the anode current collector around an outside edge of the first portion of the anode.

73-91. (canceled)
